(19) United States
(12) Patent Application Publication
(10) Pub. No.: US 2015/0281834 A1
(43) Pub. Date: Oct. 1, 2015

(54) MICROPHONE DEVICE AND MICROPHONE UNIT

(71) Applicant: Funai Electric Co., Ltd., Osaka (JP)

(72) Inventors: Rikuo TAKANO, Tokyo (JP); Masatoshi ONO, Tsukuba (JP)

(73) Assignee: FUNAI ELECTRIC CO., LTD.

(21) Appl. No.: 14/669,584

(22) Filed: Mar. 26, 2015

(30) Foreign Application Priority Data
Mar. 28, 2014 (JP) 2014-070167
Mar. 26, 2015 (JP) 2015-063665

(51) Int. Cl. H04R 1/32; H04R 1/08

(52) U.S. Cl. CPC H04R 1/326; H04R 1/08

(57) ABSTRACT

A microphone device includes an omnidirectional microphone, a directional microphone, and a first signal processor that performs subtraction processing between data outputted by the directional microphone and data outputted by the omnidirectional microphone.

### CROSS-REFERENCE TO RELATED APPLICATIONS

This application claims priority to Japanese Patent Application Nos. 2014-070167 filed on Mar. 28, 2014 and 2015-063665 filed on Mar. 26, 2015. The entire disclosure of Japanese Patent Application Nos. 2014-070167 and 2015-063665 is hereby incorporated herein by reference.

### BACKGROUND

1. Field of the Invention

The present invention generally relates to a microphone device and a microphone unit. More specifically, the present invention relates to a microphone device having an omnidirectional microphone and a directional microphone, and to a microphone unit used in the microphone device.

2. Background Information

A microphone device having a non-directional microphone and a directional microphone is known in the art (see Japanese Translation of PCT International Application Publication No. 20005-522078 (Patent Literature 1), for example).

The above-mentioned Patent Literature 1 discloses the configuration of a microphone (microphone unit) having a non-directional microphone and a unidirectional microphone. With the microphone discussed in Patent Literature 1, the non-directional microphone is directed toward a speaker's voice (the audio signal source side) and used as a voice acquisition microphone, while the unidirectional microphone is directed toward environmental noise (the noise source side) and used as a noise acquisition microphone. Audio signal processing based on a specific noise suppression algorithm (processing to remove background noise signals) is performed to extract a speaker's voice by subtracting an estimated value for environmental noise acquired by the unidirectional microphone from a speaker's voice that includes environmental noise acquired by the non-directional microphone. Furthermore, since noise is acquired by having the direction in which sensitivity is relatively high in the unidirectional microphone toward environmental noise, it is believed to be unnecessary to raise sensitivity any higher than needed. Specifically, since there is no need to widen the spacing of the plurality of diaphragms that form the unidirectional microphone, the microphone unit can be made that much more compact.

There is a known spectrum subtraction (SS) method for subtracting the environmental noise spectrum from the audio signal spectrum, which is a mix of main audio (the speaker's voice) and environmental noise, as processing to remove background noise signals based on a noise suppression algorithm. With spectrum subtraction, the environmental noise spectrum is estimated for a soundless period (a blank period in which there is no main audio) in which the main audio of a speaker is halted and only environmental noise remains, and the speaker's voice is extracted by subtracting this estimated environmental noise spectrum from the audio signal spectrum that is a mixture of environmental noise and the speaker's voice acquired in real time. With the microphone discussed in Patent Literature 1, this spectrum subtraction is applied as an example, and the configuration is such that the speaker's voice is extracted by subtracting the estimated value (average value) for environmental noise acquired by the unidirectional microphone from the speaker's voice that includes environmental noise acquired by the non-directional microphone.

### SUMMARY

However, with the microphone configuration discussed in Patent Literature 1, in performing audio signal processing by spectrum subtraction (processing to remove background noise signals), the environmental noise spectrum is estimated as an average frequency characteristic spectrum during a soundless period in which the main audio of the speaker (speaker's voice) is halted. Thus, strictly speaking, the environmental noise spectrum that is removed is believed to be different from the noise spectrum in real time. Therefore, there will be situations when the extracted speaker's voice is not properly obtained if an environmental noise spectrum that is an estimated value is subtracted from an audio signal spectrum that is a mixture of a speaker's voice and environmental noise, in which case there will be a problem in that the quality of the main audio (the speaker's voice) will decrease after audio signal processing. Also, since a conventional spectrum subtraction method involves subtracting the environmental noise spectrum obtained as an estimated value from the audio signal spectrum, there is a phenomenon that there will actually be more noise included in the main audio (speaker's voice) after audio signal processing (missing fundamental).

One aspect is to prove a microphone device and microphone unit with which a decrease in the quality of a speaker's voice after audio signal processing can be minimized, even in a compact microphone unit.

In view of the state of the known technology, a microphone device is provided that includes an omnidirectional microphone, a directional microphone, and a first signal processor that performs subtraction processing between data outputted by the directional microphone and data outputted by the omnidirectional microphone.

Also other objects, features, aspects and advantages of the present disclosure will become apparent to those skilled in the art from the following detailed description, which, taken in conjunction with the annexed drawings, discloses one embodiment of the microphone device and the microphone unit.

### BRIEF DESCRIPTION OF THE DRAWINGS

Referring now to the attached drawings which form a part of this original disclosure:

FIG. 1 is a perspective view of the configuration of a portable information terminal that incorporates a microphone unit in accordance with a first embodiment;

FIG. 2 is a bottom view of the configuration of a portable information terminal that incorporates the microphone unit in accordance with the first embodiment;

FIG. 3 is a top view of the configuration of the microphone unit in a portable information terminal in accordance with the first embodiment;

FIG. 4 is a simplified diagram of the layout relation between environmental noise and a speaker's voice with respect to the directional pattern of the microphone unit in the portable information terminal in accordance with the first embodiment;

FIG. 5 is a block diagram of an audio signal processor and the microphone unit in the portable information terminal in accordance with the first embodiment;

FIG. 6 is a graph of the relation between the sensitivity characteristics of a non-directional microphone in the portable information terminal in accordance with the first embodiment, and the sensitivity characteristics of a directional microphone before and after adjustment;

FIG. 7 is a perspective view of the configuration of a tablet terminal that incorporates a microphone unit in accordance with the second embodiment;

FIG. 8 is a top view of the configuration of the tablet terminal that incorporates the microphone unit in accordance with the second embodiment;

FIG. 9 is a diagram of the configuration of the microphone unit in the tablet terminal in accordance with the second embodiment;

FIG. 10 is a simplified diagram of the layout relation between environmental noise and a speaker's voice with respect to the directional pattern of the microphone unit in the tablet terminal in accordance with the second embodiment;

FIG. 11 is a diagram of the configuration of a microphone unit in a tablet terminal in accordance with a third embodiment;

FIG. 12 is a block diagram of an audio signal processor and a microphone unit in a portable information terminal in accordance with a fourth embodiment;

FIG. 13 shows a control processing flow related to automatic adjustment of the amplification ratio in a portable information terminal in accordance with a fifth embodiment;

FIG. 14 is a block diagram of an audio signal processor and a microphone unit in a portable information terminal in accordance with a first modification example; and

FIG. 15 is a block diagram of an audio signal processor and a microphone unit in a portable information terminal in accordance with a second modification example.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

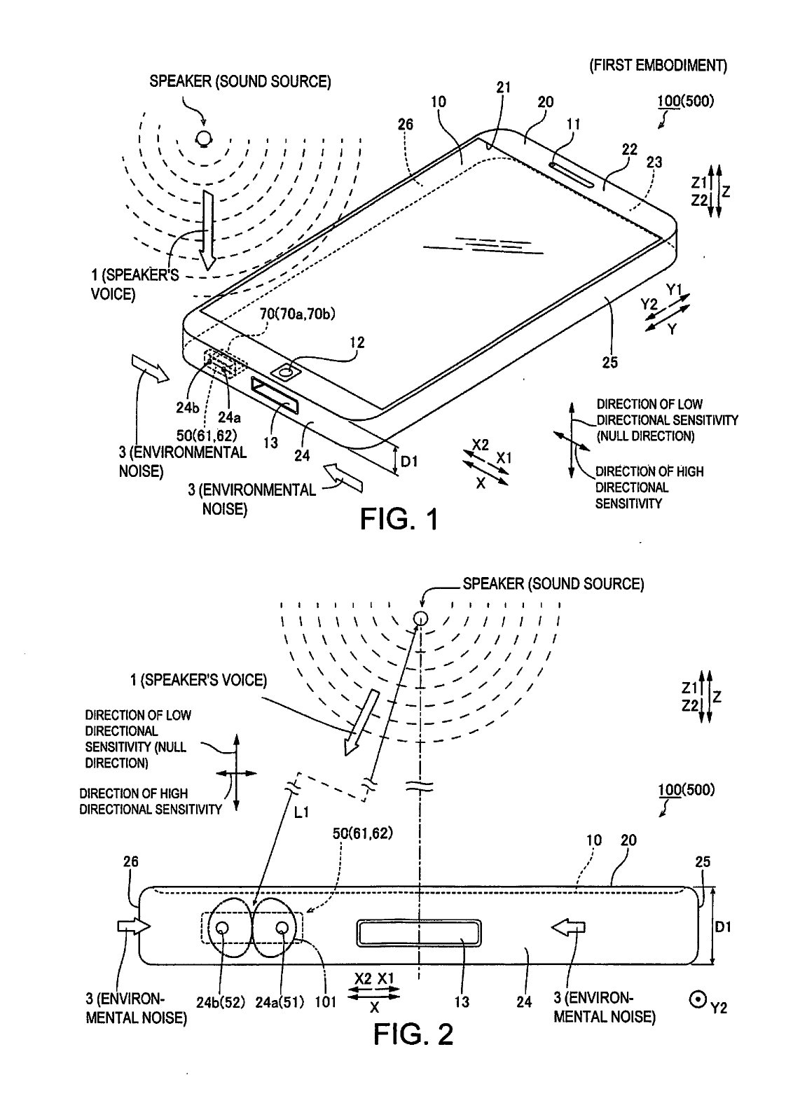

Referring initially to FIGS. 1 to 6, a portable information terminal 100 is illustrated in accordance with a first embodiment. The portable information terminal 100 is an example of the microphone device of the present invention.

As shown in FIG. 1, the portable information terminal 100 in accordance with the first embodiment includes a touch panel type of display component 10 and a housing 20 that forms the outside of the device main body and surrounds the display component 10. An example of the portable information terminal 100 is a smart phone. Specifically, the portable information terminal 100 has the function of recording a speaker's voice 1 emitted by the user (speaker), or emitting the speaker's voice 1 through a telephone line (wireless communication) to another communications device, in addition to executing specific operations by direct device manipulation by the user's finger, etc. In the illustrated embodiment, the portable information terminal 100 includes the housing 20 and the display component 10 arranged relative to the housing 20.

The portable information terminal 100 has a thin, flat shape with a thickness D1 (approximately 6 mm, for example) in the Z direction. The housing 20 has an opening 21 with a rectangular shape that exposes the display component 10, an upper face 22 (Z1 side) in the form of a frame that surrounds the opening 21, an upper end face 23 (Y1 side) and a lower end face 24 (Y2 side) that are perpendicular to the upper face 22 and extend in the short-side direction (X direction), and a side end face 25 (X1 side) and a side end face 26 (X2 side) that are perpendicular to the upper face 22 and the upper end face 23 (lower end face 24) and extend in the lengthwise direction (Y direction). The upper end face 23 (lower end face 24) here has a length (X direction) of approximately 60 mm, for example.

A speaker 11 that outputs the voice of the other party on the line, etc., and a control button 12 that is pressed (touched) when performing specific device operations are each provided at a specific location on the upper face 22 of the portable information terminal 100. Also, a connector 13 that is connected to a communications cable (not shown) is provided to the portable information terminal 100 near the center of the lower end face 24 in the X direction.

As shown in FIGS. 1 and 2, a compact microphone unit 50 (whose outer shape is indicated by a broken line) is provided on the inside of the lower end face 24 of the housing 20. The microphone unit 50 has a width of approximately 3 mm in the Z direction (approximately one-half the thickness D1 of the portable information terminal 100), and has a width of approximately 7 mm in the X direction. This extremely compact microphone unit 50 is housed in the interior of the housing 20 in a state in which the center position in the X direction is offset by a specific distance (such as about 20 mm) to one side (X2 side) of the lower end face 24 past the center position of the connector 13.

The microphone unit 50 is configured to function as a close-talking microphone that suppresses distant environmental noise 3 and captures only nearby sounds (sounds made by the mouth), but as shown in FIG. 2, is also configured so that the speaker's voice 1 can be picked up even when the microphone unit 50 (the portable information terminal 100) is at a distance L1 from the speaker. The distance L1 here is assumed to be no more than approximately 250 mm (and no less than approximately 40 mm). That is, the configuration is such that the microphone unit 50 can pick up the speaker's voice 1 with no problem even when the portable information terminal 100 is a distance of distinct vision away (the minimum distance at which the display component 10 can be clearly seen by the user (speaker) without eye fatigue).

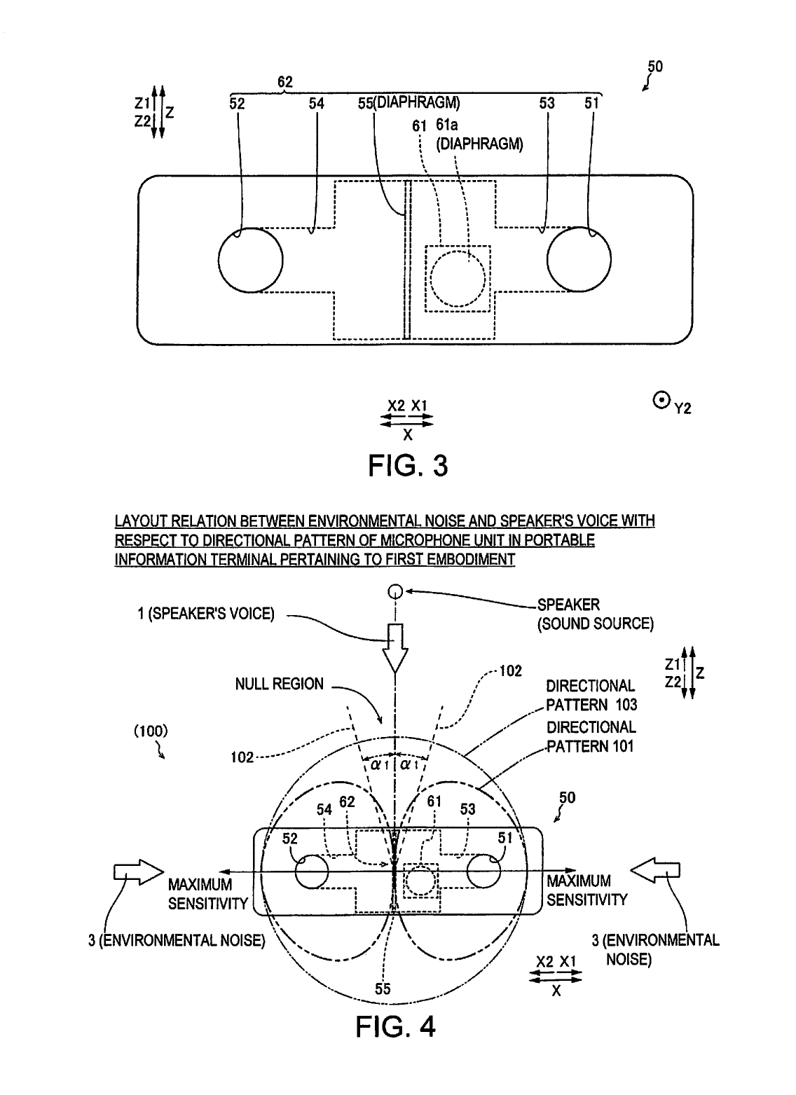

As shown in FIG. 3, the microphone unit 50 has a pair of sound holes 51 (X1 side) and 52 (X2 side) having an inside diameter of approximately 1 mm, a sound path 53 that extends in the arrow X2 direction from the sound hole 51, a sound path 54 that extends from the sound hole 52 through the interior along the arrow X1 direction, and a differential diaphragm 55 provided so as to block off the sound path 53 and the sound path 54. The sound hole 51 and the sound hole 52 are aligned in the X direction substantially perpendicular to the Z direction from which the speaker's voice 1 (see FIG. 2) arrives, while being spaced approximately 5 mm apart. A bidirectional microphone 62 is formed by the sound holes 51 and 52, the sound paths 53 and 54, and the diaphragm 55. Specifically, the sound pressures inputted through of the sound holes 51 and 52 are each transmitted to one surface (X1 side) of the diaphragm 55 and to the other surface (X2 side). The diaphragm 55 is then vibrated by the difference in sound pressure between the two surfaces, and this vibration change is outputted as an electrical signal from the bidirectional microphone 62. The bidirectional microphone 62 is an example of the “bidirectional microphone” of the present invention.

As shown in FIGS. 2 and 4, the bidirectional microphone 62 has a substantially figure eight-shaped bidirectional pattern (the range of directionality is indicated by the two-dot chain line 101). In this case, the configuration is such that the sensitivity is highest in the direction that links the centers of the sound holes 51 and 52 (X direction), and is lowest (no sensitivity) in the direction (Z direction) perpendicular to this direction (X direction). In FIG. 4, the angle range of deviation from the substantially figure eight-shaped directional pattern (in FIG. 4, the region having the angle α1 to the left and right and flanked by the two broken lines 102) is a direction in which there is absolutely no sensitivity to acoustic waves (audio), and is known as the null region (region of no sensitivity). A pair of holes 24a and 24b having an inside diameter of approximately 1 mm is formed in the lower end face 24 of the housing 20, with the holes spaced apart by about 5 mm. The microphone unit 50 is disposed so that the sound hole 51 is superposed over the rear side of the hole 24a on the lower end face 24, and the sound hole 52 is superposed over the rear side of the hole 24b.

As shown in FIG. 3, one non-directional microphone 61 (omnidirectional microphone) (indicated a broken line) fits into the space inside the sound path 53. That is, the microphone unit 50 includes the non-directional microphone 61 and the bidirectional microphone 62. An omnidirectional diaphragm 61a is built into the non-directional microphone 61, and the non-directional microphone 61 has the function of simultaneously acquiring both the environmental noise 3 and the speaker's voice 1 arriving through the sound hole 51 into the sound path 53. The non-directional microphone 61 has a 360-degree directional pattern (the directionality is indicated by the two-dot chain line 103 in FIG. 4), and the diaphragm 61a has the function of detecting acoustic waves (audio) at the same sensitivity from all directions, and outputting an electrical signal.

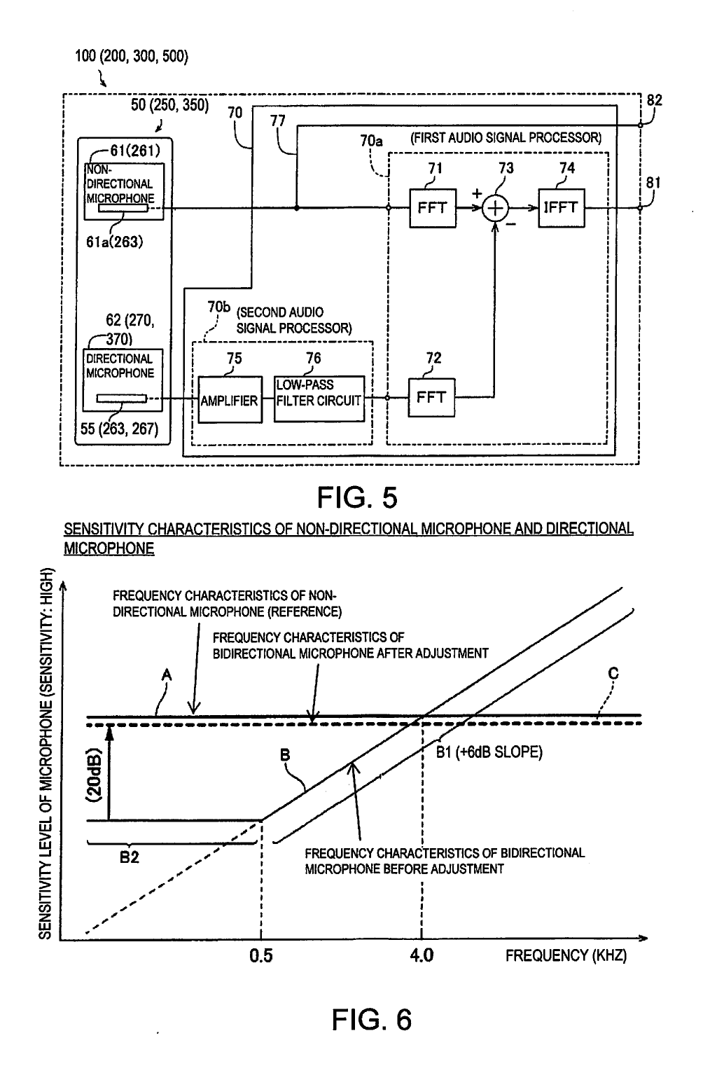

As shown in FIG. 5, the portable information terminal 100 also includes an audio signal processor 70 (signal processor) for performing specific audio signal processing on the electrical signals (audio signals) outputted from the microphone unit 50. Specifically, the non-directional microphone 61 and the bidirectional microphone 62 are each electrically connected to the audio signal processor 70. The configuration is such that electrical signals (audio signals) that have passed through the audio signal processor 70 are outputted to a control circuit (not shown) on the device main body side of the portable information terminal 100.

The audio signal processor 70 also has a first audio signal processor 70a (first signal processor) (indicated by a broken line) for performing audio signal processing (discussed below), and a second audio signal processor 70b (second signal processor) (indicated by a broken line) for performing specific audio signal processing (preprocessing) on the electrical signals (audio signals) inputted to the first audio signal processor 70a and outputted from the bidirectional microphone 62. The audio signal processor 70 includes a microcomputer or microprocessor with a program that controls the first audio signal processor 70a and the second audio signal processor 70b. The audio signal processor 70 can also include other conventional components such as an input interface circuit, an output interface circuit, and storage devices such as a ROM (Read Only Memory) device and a RAM (Random Access Memory) device. The storage devices store processing results and control programs. Specifically, the internal RAM stores statuses of operational flags and various control data. The internal ROM stores the control programs for various operations. Of course, the audio signal processor 70 can be configured to be capable of selectively controlling any of the components of the portable information terminal 100 in accordance with the control program. Alternatively, the portable information terminal 100 can further includes a microcomputer or microprocessor for controlling various components of the portable information terminal 100 including the audio signal processor 70. It will be apparent to those skilled in the art from this disclosure that the precise structure and algorithms for the audio signal processing of the present application can be realized by any combination of hardware and software that will carry out the functions of the present application.

The first audio signal processor 70a is made up of an FFT (fast Fourier transform) component (or circuit) 71 and an FFT (fast Fourier transform) component (or circuit) 72 for obtaining frequency characteristics (spectrum) for the electrical signals (audio signals) by performing fast Fourier transformation, a subtractor (circuit) 73, and an IFFT (inverse fast Fourier transform) component (or circuit) 74 for obtaining electrical signals (audio signals) from the frequency characteristics (spectrum) by performing inverse fast Fourier transformation. The non-directional microphone 61 is electrically connected to the FFT component 71, and the bidirectional microphone 62 is electrically connected to the FFT component 72. The role of the subtractor 73 is to exclude (subtract) the spectrum obtained by the FFT component 72 from the spectrum obtained by the FFT component 71. The IFFT component 74 disposed downstream from the subtractor 73 is connected to a terminal 81. The audio signal obtained by the IFFT component 74 (an audio signal in which noise has been reduced) is outputted through the terminal 81 to a control circuit or CPU (not shown) on the device main body side of the portable information terminal 100.

The second audio signal processor 70b is disposed between the bidirectional microphone 62 and the first audio signal processor 70a. Specifically, the second audio signal processor 70b is electrically disposed between the bidirectional microphone 62 and the first audio signal processor 70a. The second audio signal processor 70b is made up of an amplifier (circuit) 75 for adjusting the sensitivity level of the electrical signals (audio signals) outputted from the bidirectional microphone 62, and a low-pass filter circuit 76 that is connected to the downstream side of the amplifier 75. Specifically, the second audio signal processor 70b is provided for the purpose of adjusting the electrical conditions had by the electrical signals (audio signals) outputted from the bidirectional microphone 62, and effectively obtain audio signal processing (processing to remove background noise signals) in the first audio signal processor 70a.

As shown in FIG. 1, with the portable information terminal 100, the microphone unit 50, which has the non-directional microphone 61 and the bidirectional microphone 62, is provided in a narrow region on the inside of the lower end face 24, and the microphone unit 50 is connected to a control circuit (not shown) on the device main body side via the audio signal processor 70. The orientation of the bidirectional microphone 62 built into the microphone unit 50 (the orientation of the substantially figure eight-shaped directional pattern) faces in the direction in which the effect of audio signal processing (processing to remove background noise signals) by the audio signal processor 70 is intended to be favorably obtained. Consequently, the following audio signal processing (processing to remove background noise signals) is carried out when the user's voice (the speaker's voice 1) is inputted by the microphone unit 50 in the portable information terminal 100.

More specifically, in the first embodiment, as shown in FIGS. 1 and 2, the microphone unit 50 is housed in the interior of the housing 20 so that it will be possible for the bidirectional microphone 62 to acquire the environmental noise 3 from the direction in which directional sensitivity is relatively high (a direction that is mainly along the X direction perpendicular to the Z direction) by having the null direction in which directional sensitivity is relatively low (the arrow Z1 direction in which the display component 10 faces) face toward the speaker's voice 1 emitted by the speaker (sound source). As shown in FIG. 5, in a state in which the microphone unit 50 is installed in the above-mentioned direction, the audio signal processor 70 (the first audio signal processor 70a) performs subtraction processing (audio signal processing to subtract the environmental noise 3 from the speaker's voice 1 including the environmental noise 3 (processing to remove background noise signals)) on both the speaker's voice 1 including the environmental noise 3 acquired by the non-directional microphone 61, and the environmental noise 3 acquired by the bidirectional microphone 62 when both of these are present. Here, a situation in which the data sets acquired by the non-directional microphone 61 and the bidirectional microphone 62 are both present encompasses a situation in which the environmental noise 3 is acquired by the bidirectional microphone 62 at the same timing as the non-directional microphone 61. The speaker's voice 1 including the environmental noise 3 acquired by the non-directional microphone 61 is an example of the “data outputted by the omnidirectional microphone” in the present invention. The environmental noise 3 acquired by the bidirectional microphone 62 is an example of the “data outputted by the directional microphone” in the present invention. Thus, in the illustrated embodiment, the first audio signal processor 70a performs the subtraction processing in which the data outputted by the bidirectional microphone 62 is subtracted from the data outputted by the non-directional microphone 61. Also, in the illustrated embodiment, the first audio signal processor 70a performs the subtraction processing in which the data outputted by the bidirectional microphone 62 is subtracted from the data outputted by the non-directional microphone 61 after the second audio signal processor 70b performing the data processing of the data inputted from the bidirectional microphone 62. Also, in the illustrated embodiment, as shown in FIGS. 1 and 2, the bidirectional microphone 62 is arranged inside the housing 20 such that a direction (e.g., the null direction) in which the bidirectional microphone 62 has a lowest directional sensitivity is parallel to the arrow Z1 direction from the bidirectional microphone 62 toward the display component 10. Furthermore, as shown in FIGS. 1 and 2, the bidirectional microphone 62 is arranged inside the housing 20 such that the direction (e.g., the null direction) in which the bidirectional microphone 62 has the lowest directional sensitivity is parallel to a normal direction (e.g., the arrow Z1 direction) of the upper face 22 of the portable information terminal 100.

Specifically, the first audio signal processor 70a uses the subtractor 73 to subtract the spectrum mapped in a spectrum space by Fourier transformation by the FFT component 72 of the environmental noise 3 acquired by the bidirectional microphone 62, from the spectrum mapped in a spectrum space by Fourier transformation by the FFT component 71 of the speaker's voice 1 including the environmental noise 3 acquired by the non-directional microphone 61. Audio signal processing is then performed so that the spectrum in which the environmental noise 3 has been reduced is subjected to inverse Fourier transformation by the IFFT component 74 to return to a real time space, and the speaker's voice 1 from which as much of the environmental noise 3 as possible has been removed is extracted.

The non-directional microphone 61 picks up the speaker's voice 1 including the environmental noise 3 that varies from moment to moment. The bidirectional microphone 62 picks up the environmental noise 3 that varies from moment to moment. With the first audio signal processor 70a, continuous spectrum subtraction processing is performed by independently and simultaneously subjecting the electrical signals (audio signals) based on the speaker's voice 1 including the environmental noise 3 that is picked up by the non-directional microphone 61 and that varies from moment to moment, and the electrical signals (audio signals) based on the environmental noise 3 that is picked up by the bidirectional microphone 62 and that varies from moment to moment, to fast Fourier transformation. The electrical signals (audio signals) that have undergone continuous spectrum subtraction processing are then subjected to inverse fast Fourier transformation to extract the speaker's voice 1.

As an example, a frame length of 5 ms, a frame period of 2.6 ms, and a window function of a hamming window are set as the processing conditions during fast Fourier transformation. Under these conditions, the distance L1 between the speaker (sound source) and the microphone unit 50 (see FIG. 2) is set at approximately 250 mm, and the sound source of the environmental noise 3 is disposed at a position approximately 1 m away from the microphone unit 50 along the maximum sensitivity direction of the bidirectional microphone 62 (the X direction). The speaker's voice 1 emitted from the speaker (sound source) is measured after undergoing audio signal processing by the audio signal processor 70 (first audio signal processor 70a). As a result, the S/N ratio (signal to noise ratio) of the speaker's voice 1 and the environmental noise 3 is approximately 20 dB, and it is found that good results could be obtained in processing to remove background noise signals.

If the spectrum subtraction processing at the first audio signal processor 70a results in a negative value (that is, if the spectrum of the environmental noise 3 is larger than the spectrum of the speaker's voice 1 at a specific frequency), the subtraction value can be replaced with “zero.”

In the first embodiment, the second audio signal processor 70b (see FIG. 5) has the function of performing audio signal processing for bringing the frequency characteristics of the bidirectional microphone 62 close to the frequency characteristics of the non-directional microphone 61. Specifically, the maximum sensitivity level of the electrical signals (audio signals) outputted from the bidirectional microphone 62 is first offset by the amplifier 75 (see FIG. 5). In this case, since the bidirectional microphone 62 has a substantially figure eight-shaped directional pattern (two-dot chain line 101), the sensitivity varies with the direction of the environmental noise 3 (a direction that is inclined in the Z1 direction or the Z2 direction by a specific angle from the X direction in which the maximum sensitivity is obtained). As an example, the environmental noise 3 that arrives at an angle of approximately 45 degrees to the maximum sensitivity axis (the X direction) has an overall decrease in its sensitivity level of approximately 3 dB. Therefore, to even out the difference in sensitivity level due to the direction in which the environmental noise 3 arrives, the characteristics of the amplifier 75 can be adjusted so that the sensitivity is offset by approximately 3 dB higher. This also makes it possible to even out how well the environmental noise 3 is removed by audio signal processing (processing to remove background noise signals) at the first audio signal processor 70a, without greatly affecting the angle at which the environmental noise 3 arrives at the bidirectional microphone 62.

Also, the configuration is such that the sensitivity characteristics (frequency characteristics) originally had by the bidirectional microphone 62 are flattened by passing the electrical signals (audio signals) through the low-pass filter circuit 76 downstream of the amplifier 75 (see FIG. 5). Consequently, the configuration is such that the sensitivity characteristics (frequency characteristics) after passage through the low-pass filter circuit 76 will be moved closer to the sensitivity characteristics (frequency characteristics) of the non-directional microphone 61.

As shown in FIG. 6, as an example, first the non-directional microphone 61 has flat frequency characteristics A (meaning that the sensitivity is substantially consistent regardless of the frequency; indicated by a thick solid line). In contrast, the bidirectional microphone 62 has frequency characteristics B (indicated by a thin solid line) in its original state prior to input to the second audio signal processor 70b (see FIG. 5). Of the frequency characteristics B that bend, the characteristics B1 (the inclined, straight portion) are the characteristics (maximum sensitivity) for environmental noise 3 from far away from the bidirectional microphone 62 (approximately 0.5 m or farther), and increase along with frequency (an upward slope of approximately +6 dB), intersecting with the frequency characteristics A of the non-directional microphone 61 near 4 kHz. In the low frequency region, the bidirectional microphone 62 has the flat characteristics B2 at approximately 0.5 kHz and below, and this level is approximately 20 dB lower than the flat frequency characteristics A of the non-directional microphone 61.

Therefore, by passing the output signal of the bidirectional microphone 62 through the amplifier 75 (see FIG. 5), first the frequency characteristics B of the bidirectional microphone 62 (the characteristics B2+the characteristics B1) are increased in overall gain by about 20 dB, which moves them closer to the frequency characteristics A of the non-directional microphone 61. Then, the frequency characteristics B are flattened out by putting in the low-pass filter circuit 76, which is set to have a downward slope of approximately −6 dB at the 0.5 kHz portion. Thus, the configuration is such that the frequency characteristics B are adjusted to frequency characteristics C (indicated by a thick broken line) that are the same as the frequency characteristics A. The second audio signal processor 70b changes the sensitivity characteristics of the bidirectional microphone 62 from the frequency characteristics B to the frequency characteristics C. As shown in FIG. 5, audio signal processing is then performed by the amplifier 75 and the low-pass filter circuit 76 (processing to change the sensitivity characteristics of the bidirectional microphone 62), after which spectrum subtraction processing is performed by the first audio signal processor 70a.

After the second audio signal processor 70b has thus performed signal processing to move the frequency characteristics of the bidirectional microphone 62 closer to the frequency characteristics of the non-directional microphone 61, the first audio signal processor 70a performs audio signal processing (processing to remove background noise signals) in which the speaker's voice 1 with reduced environmental noise 3 is extracted by subtracting the environmental noise 3 that is acquired by the bidirectional microphone 62 and that has undergone signal processing by the second audio signal processor 70b, from the speaker's voice 1 including the environmental noise 3 acquired by the non-directional microphone 61.

As shown in FIG. 4, in the first embodiment, the bidirectional microphone 62 is configured so as to be inclined with respect to the speaker's voice 1, having an angle range of within 30 degrees to one side (the X1 side) or the other side (the X2 side) toward the maximum sensitivity axis (the X direction), centered on the null direction (the Z direction) with the lowest directional sensitivity. Specifically, the maximum value for the angle α1 provided on the left and right is 30 degrees for each, and the layout position of the microphone unit 50 is set so that the speaker's voice 1 will arrive at the bidirectional microphone 62 (although the speaker's voice 1 is not picked up) within the range of this angle α1.

In FIG. 2, for example, if the microphone unit 50 is disposed about 20 mm to the X2 side from the center position (X direction) of the portable information terminal 100, the above-mentioned condition will be met if the distance L1 is at least approximately 40 mm. Therefore, if the speaker's voice 1 is emitted from a position at a distance of distinct vision (distance L1=approximately 250 mm), then the speaker's voice 1 will adequately fall within the range of the angle α1, and in that state only the environmental noise 3 will be picked up by the microphone unit 50 (the bidirectional microphone 62). Also, since the environmental noise 3 is substantially perpendicular to the speaker's voice 1 coming from a position that is a distance of distinct vision away, the speaker's voice 1 arriving from approximately the Z direction will not affect the environmental noise 3 that comes around to the X1 side or the X2 side and is mainly picked up by the bidirectional microphone 62.

In actual measurement, the effect of wraparound of the speaker's voice 1 to the environmental noise 3 (wraparound of the speaker's voice 1 from the arrow Z2 direction to the arrow X1 direction and the arrow X2 direction) is approximately −20 dB, and the effect on the environmental noise 3 is considered negligible. On the other hand, the environmental noise 3 that reaches the bidirectional microphone 62 from the X1 direction or the X2 direction perpendicular to the speaker's voice 1 is acquired at good sensitivity. Therefore, if the bidirectional microphone 62 is facing toward the speaker's voice 1 in an angle range of no more than 30 degrees to one side or the other, toward the maximum sensitivity axis (X direction), centered on the null direction in which directional sensitivity is lowest, then for practical purposes the environmental noise 3 will be acquired without any problem. Therefore, separation of the speaker's voice 1 and the environmental noise 3 will be possible even though the position of the speaker's voice 1 is a distance of distinct vision (approximately 250 mm) away from the display component 10 of the portable information terminal 100.

As another thing to consider, the closer the speaker's voice 1 is to the microphone unit 50 (the bidirectional microphone 62), the less is the effect of wraparound of the speaker's voice 1 (in FIG. 2, wraparound of the speaker's voice 1 from the arrow Z2 direction to the arrow X1 direction and the arrow X2 direction). Accordingly, it has been experimentally confirmed that performance in separating the environmental noise 3 from the speaker's voice 1 is improved when the null direction of the bidirectional microphone 62 is faced toward the speaker's voice 1. In addition, the environmental noise 3 coming from far away is affected by the surrounding environment and is repeatedly reflected, refracted, and so forth, so the sharply constricted shape of the region of no sensitivity (null direction) of the bidirectional microphone 62 tends to be moderated. Consequently, the sensitivity of the environmental noise 3 rises over a wide angle centered on the maximum sensitivity axis (X direction), and the bidirectional microphone 62 can effectively function as a noise sensor. Furthermore, the effect on environmental noise 3 is only about −10 dB even if the speaker's voice 1 is inclined by about ±20 degrees in the direction of the maximum sensitivity axis (X direction) from the center of the bidirectional microphone 62 in the null direction. Moreover, the effect on environmental noise 3 is about −6 dB even if the speaker's voice 1 is inclined by about ±30 degrees in the direction of the maximum sensitivity axis (X direction) from the center in the null direction, and the effect will fall within a practically permissible range under any conditions.

Consequently, with the portable information terminal 100, even when the speaker's voice 1 is emitted from a position where the speaker (user) is a distance of distinct vision away (about 250 mm), because the audio signal processor 70 is provided, which performs independent audio signal processing (processing to remove background noise signals) so that the orientation is properly set to take into account the directional characteristics (substantially figure eight-shaped directional pattern) of the bidirectional microphone 62 built into the microphone unit 50, and is matched to the orientation that takes into account the directional characteristics of the bidirectional microphone 62, the environmental noise 3 can be minimized along with clearly distinguishing (determining) the environmental noise 3 from the voice emitted by the speaker (the speaker's voice 1 originally included in the environmental noise 3), and the original speaker's voice 1 can be extracted in a state that is close to how it was at the outset.

As shown in FIG. 5, in the first embodiment, a wire 77 is provided to the audio signal processor 70 to branch off the output of the non-directional microphone 61 between the non-directional microphone 61 and the FFT (fast Fourier transformation) component 71. The wire 77 is connected to a terminal 82. Consequently, the portable information terminal 100 is configured so that the speaker's voice 1 acquired by the non-directional microphone 61 can be outputted in an amplified state from the speaker 11 of the device main body without going through the audio signal processor 70, or the speaker's voice 1 acquired by the non-directional microphone 61 can be outputted to another communications device as voice communication without going through the audio signal processor 70, by means of a switching operation or the like on the device main body side. The portable information terminal 100 in the first embodiment is configured as above.

The first embodiment has the following effects.

As discussed above, the portable information terminal 100 in accordance with the first embodiment includes the non-directional microphone 61, the bidirectional microphone 62 that acquires the environmental noise 3 from a direction in which directional sensitivity is relatively high by facing the null direction in which directional sensitivity is relatively low toward the speaker's voice 1, and the first audio signal processor 70a that performs audio signal processing in which the speaker's voice 1 with reduced environmental noise 3 is extracted by subtracting environmental noise 3 acquired by the bidirectional microphone 62, from a speaker's voice 1 that includes environmental noise 3 acquired by the non-directional microphone 61. Therefore, background noise signals can be removed based on audio signal processing that is continuous and proceeds simultaneously for the speaker's voice 1 including the environmental noise 3 acquired independently by the non-directional microphone 61, and for the environmental noise 3 acquired independently by the bidirectional microphone 62. Specifically, unlike when using a conventional spectrum subtraction method to subtract the estimated value (average value) for the environmental noise 3 acquired during a soundless period (a blank period in which there is no main audio) in which the speaker's voice 1 is halted, from the speaker's voice 1 that includes environmental noise 3 acquired in real time, the speaker's voice 1 can be extracted by subtracting the environmental noise 3 present at the same clock time from the speaker's voice 1 that includes the environmental noise 3, which allows main audio that is that much closer to the original (a speaker's voice 1 that is more natural) to be obtained. Furthermore, because the microphone unit 50 includes the non-directional microphone 61 and the bidirectional microphone 62 that acquires the environmental noise 3 from the direction in which directional sensitivity is relatively high by having the null direction in which directional sensitivity is relatively low face toward the speaker's voice 1, there is no need to increase the sensitivity of the bidirectional microphone 62 that acquires the environmental noise 3 more than necessary, so the microphone unit 50 that forms the portable information terminal 100 (e.g., the microphone device) can be made more compact. Consequently, a decrease in the quality of the speaker's voice 1 after audio signal processing can be suppressed even in the microphone unit 50 that has been made more compact.

Also, in the first embodiment, the first audio signal processor 70a performs audio signal processing in which the environmental noise 3 acquired by the bidirectional microphone 62 is subtracted from the speaker's voice 1 that includes the environmental noise 3 acquired by the non-directional microphone 61, and therefore the audio signal processing performed by the first audio signal processor 70a can also suitably correspond to removing spontaneous non-stationary noise, to the extent that the speaker's voice 1 can be extracted by capturing, simultaneously and in parallel, the speaker's voice 1 that includes the environmental noise 3 that varies from one moment to the next, with the non-directional microphone 61 and the directional microphone 62, and subtracting. Specifically, since noise elimination processing can be reliably performed with respect to transient fluctuations in the environmental noise 3, the speaker's voice 1 can be obtained in a state in which so-called musical noise (tonal noise produced as a side effect of noise suppression) is almost completely excluded. Consequently, the speaker's voice 1 can be obtained with good clarity (the speaker's voice 1 from which musical noise has been excluded). Also, since the speaker's voice 1 can be obtained with good clarity, a sound source (the speaker's voice 1) with high voice recognition performance can also be obtained.

Also, in the first embodiment, since the microphone unit 50 is made smaller by using a single non-directional microphone 61, there is no need to perform signal processing in an extremely short time to determine the direction in which the speaker's voice 1 is arriving based on the phase difference between a plurality of diaphragms, or to determine the spectrum of the speaker's voice 1 by executing autocorrelation. Therefore, there is no need to install a high-performance signal processor (digital signal processor) with excellent processing capability in the portable information terminal 100, so the portable information terminal 100 equipped with the microphone unit 50 can be offered to a wider market.

Also, in the first embodiment, the second audio signal processor 70b is further provided to perform signal processing for moving the frequency characteristics of the bidirectional microphone 62 closer to the frequency characteristics of the non-directional microphone 61. The first audio signal processor 70a then performs audio signal processing in which the speaker's voice 1 with reduced environmental noise 3 is extracted by subtracting the environmental noise 3 that is acquired by the bidirectional microphone 62 and that has undergone signal processing by the second audio signal processor 70b, from the speaker's voice 1 including the environmental noise 3 acquired by the non-directional microphone 61. Consequently, the audio signal processing of the first audio signal processor 70a (processing to extract the speaker's voice 1 by subtracting the environmental noise 3 acquired at the same timing from the speaker's voice 1) can be performed in a state in which the frequency characteristics of the non-directional microphone 61 and the frequency characteristics of the directional microphone 62 are matched to substantially the same electrical characteristics by the second audio signal processor 70b.

Also, in the first embodiment, the second audio signal processor 70b is disposed between the bidirectional microphone 62 and the first audio signal processor 70a, and the amplifier 75 and the low-pass filter circuit 76 that adjust the output level are connected in that order. Consequently, the second audio signal processor 70b can easily match the sensitivity characteristics (frequency characteristics) of the bidirectional microphone 62 to the sensitivity characteristics (frequency characteristics) of the non-directional microphone 61. That is, the second audio signal processor 70b, to which the amplifier 75 and the low-pass filter circuit 76 are connected in that order, can easily obtain the electrical conditions necessary for removing the environmental noise 3 acquired by the bidirectional microphone 62, from the speaker's voice 1 including the environmental noise 3 acquired by the non-directional microphone 61.

Also, in the first embodiment, the first audio signal processor 70a is configured so as to perform audio signal processing in which the spectrum obtained by subjecting the environmental noise 3 acquired by the bidirectional microphone 62 to Fourier transformation is subtracted from the spectrum obtained by subjecting the speaker's voice 1 including the environmental noise 3 acquired by the non-directional microphone 61 to Fourier transformation, after which the spectrum in which environmental noise 3 has been reduced is subjected to inverse Fourier transformation to extract the speaker's voice 1. Consequently, the speaker's voice 1 can be easily extracted by subtracting the environmental noise 3 acquired at good sensitivity by the bidirectional microphone 62, from the speaker's voice 1 including the environmental noise 3 acquired by the non-directional microphone 61.

Also, in the first embodiment, the microphone unit 50 is configured using the bidirectional microphone 62. Consequently, the figure eight-shaped directionality (bidirectionality) of the bidirectional microphone 62 can be effectively utilized to acquire the environmental noise 3 at good sensitivity. The existing bidirectional microphone 62 can be used to easily obtain a portable information terminal 100 in which the decrease in the quality of the speaker's voice 1 after audio signal processing can be suppressed.

Also, in the first embodiment, the layout of the microphone unit 50 in the housing 20 is configured so that the bidirectional microphone 62 faces toward the speaker's voice 1 in an angle range of no more than 30 degrees (an angle range α1 to the left and right) to one side (the X1 side) or the other side (the X2 side) toward the maximum sensitivity axis (the X direction), centered on the Z direction (the null direction) with the lowest directional sensitivity. Consequently, even if the bidirectional microphone 62 (the microphone unit 50) is disposed at an angle to the speaker's voice 1 within the non-sensitivity region (the null region; the angle range in which no directional sensitivity is obtained) of ±30 degrees or less, the bidirectional microphone 62 will not pick up the speaker's voice 1, and the environmental noise 3 arriving at the bidirectional microphone 62 from the X1 direction and the X2 direction perpendicular to the speaker's voice 1 can be acquired at good sensitivity. As long as the bidirectional microphone 62 is thus facing toward the speaker's voice 1 in an angle range of no more than 30 degrees to one side or the other, toward the maximum sensitivity axis (X direction), centered on the null direction in which directional sensitivity is lowest, then for practical purposes the environmental noise 3 can be acquired without any problem.

Also, in the first embodiment, the bidirectional microphone 62 is configured so that the maximum sensitivity level can be offset. Consequently, even if there is a change (decrease) in the sensitivity of the bidirectional microphone 62 attributable to the direction in which the environmental noise 3 reaches the bidirectional microphone 62 having figure eight-shaped directionality (a direction that is inclined by a specific angle from the direction in which maximum sensitivity is obtained), since the maximum sensitivity level can be offset (increased), there will be less change (decrease) in the microphone sensitivity according to the direction in which the environmental noise 3 arrives. That is, the angle at which environmental noise 3 reaches the bidirectional microphone 62 is not greatly affected, and the environmental noise 3 removal performance had by audio signal processing at the first audio signal processor 70a (processing to extract the speaker's voice 1 by subtracting the environmental noise 3 from the speaker's voice 1 including the environmental noise 3) can be made more uniform.

Also, in the first embodiment, the bidirectional microphone 62 is configured so that acoustic waves are detected based on the difference in sound pressure arriving at the one diaphragm 55 from the opposite direction via the sound hole 51 and the sound hole 52. The microphone unit 50 is configured so that the non-directional microphone 61 is disposed within the sound path 53 that connects one sound hole 51 with one side (the X1 side) of the diaphragm 55. This allows the non-directional microphone 61 to be disposed within the sound path 53 (inside the cavity) forming the bidirectional microphone 62, so compared to when the non-directional microphone 61 is disposed on the outside of the bidirectional microphone 62, the size of the microphone unit 50 can be reduced because the non-directional microphone 61 is built into the bidirectional microphone 62.

Also, in the first embodiment, the configuration is such that the pair of sound holes 51 and 52 forming the bidirectional microphone 62 are disposed so as to be aligned in the X direction that is substantially perpendicular to the Z direction in which the speaker's voice 1 arrives. Consequently, the bidirectional microphone 62 can be easily disposed in the interior of the housing 20 so that the direction in which directional sensitivity is relatively low (null region: within an angular range in which no sensitivity is obtained with directionality) faces in the direction in which the speaker's voice 1 arrives (the arrow Z1 direction), and the environmental noise 3 is acquired from the direction in which directional sensitivity is relatively high (the arrow X1 direction and the arrow X2 direction that intersect the direction in which the speaker's voice 1 arrives).

Also, in the first embodiment, the wire 77 and the terminal 82 are providing for outputting the speaker's voice 1 acquired by the non-directional microphone 61 without going through the first audio signal processor 70a. This allows the function of audio signal processing performed by the first audio signal processor 70a (processing to extract the speaker's voice 1 by subtracting the environmental noise 3 from the speaker's voice 1 including the environmental noise 3) to be added also to the portable information terminal 100 equipped with an amplification function for outputting the speaker's voice 1 including the environmental noise 3 directly from the speaker 11 or the like. This makes it possible to provide a portable information terminal 100 that is more useful (practical).

### Second Embodiment

Referring now to FIGS. 1, 5 and 7 to 10, a tablet terminal 200 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. With the tablet terminal 200 in the second embodiment, unlike in the first embodiment above, a microphone unit 250 is configured using a unidirectional microphone 270. In the drawings, those components that are the same as in the first embodiment will be numbered the same as in the first embodiment. The tablet terminal 200 is an example of the “microphone device” of the present invention. The unidirectional microphone 270 is an example of the “directional microphone” of the present invention.

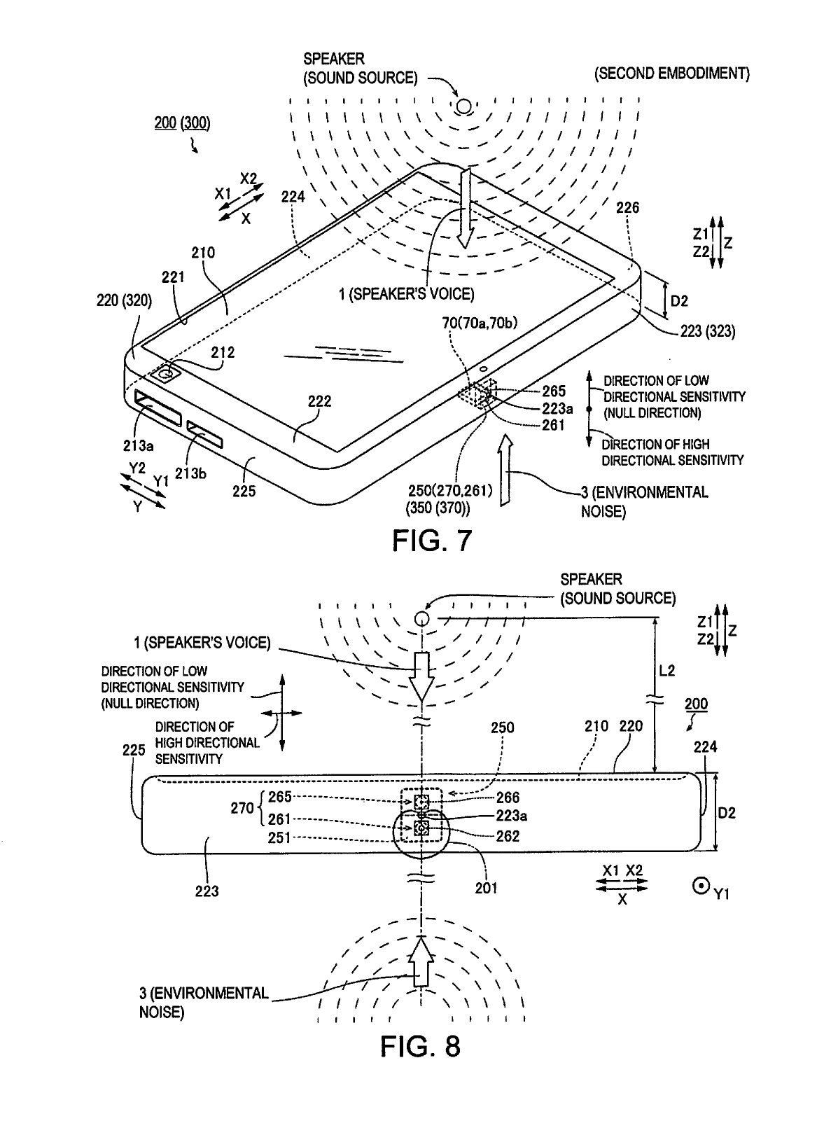

As shown in FIG. 7, the tablet terminal 200 in accordance with the second embodiment includes a touch panel type of display component 210, and a housing 220 that forms the exterior shape of the device main body and surrounds the display component 210. The tablet terminal 200 here is larger than the portable information terminal 100 (see FIG. 1). Also, with the tablet terminal 200, in addition to specific operations being executed by direction device manipulation with the user's finger, etc., there is also the function of recording the speaker's voice 1 emitted by the user (speaker), and emitting the speaker's voice 1 to another communications device via the Internet (wireless communication). In the illustrated embodiment, the tablet terminal 200 includes the housing 220 and the display component 210 arranged relative to the housing 220.

The tablet terminal 200 has a thin, flat shape, and has a thickness D2 (such as approximately 12 mm) in the Z direction. The housing 220 has a rectangular opening 221 that exposes the display component 210, a frame-shaped upper face 222 (Z1 side) that surrounds the opening 221, an upper end face 223 (Y1 side) and a lower end face 224 (Y2 side) that extend in the lengthwise direction (X direction) and are perpendicular to the upper face 222, and a side end face 225 (X1 side) and a side end face 226 (X2 side) that extend in the short-side direction (Y direction) and are perpendicular to the upper face 222 and the upper end face 223 (lower end face 224). The upper end face 223 (lower end face 224) here has a length (X direction) of approximately 210 mm, for example.

Also, the tablet terminal 200 is provided with a speaker (not shown) that outputs audio and so forth, and a control button 212 that is pressed (touched) to perform specific device operations. The tablet terminal 200 is also provided with connectors 213a and 213b that are connected to communication cables (not shown) on the side end face 225.

As shown in FIGS. 7 and 8, a small microphone unit 250 (the exterior shape of which is indicated by broken lines) is provided on the inside of the upper end face 223 of the housing 220. The microphone unit 250 has a width of approximately 5 mm in the X direction, and a width of approximately 9 mm in the Z direction. This extremely compact microphone unit 250 is housed in the interior of the housing 220 in a state in which the center position in the X direction is aligned with the center position of the tablet terminal 200. In FIG. 8, the size of the microphone unit 250 is shown somewhat larger.

As shown in FIG. 8, the microphone unit 250 is configured to have the function of picking up the speaker's voice 1 in a state in which there is a distance L2 between the speaker (user) and the microphone unit 250 (the tablet terminal 200). Here again, the distance L2 is assumed to be approximately 250 mm at most.

As shown in FIG. 9, the microphone unit 250 is mounted on a substrate 251 in a state in which a set of a non-directional microphone 261 (omnidirectional microphone) and a non-directional microphone 265 (omnidirectional microphone) are close to each other. The non-directional microphone 261 has a sound hole 262 with an inside diameter of approximately 1 mm, and an omnidirectional diaphragm 263. Similarly, the non-directional microphone 265 has a sound hole 266 with an inside diameter of approximately 0.3 mm, and an omnidirectional diaphragm 267. An air-permeable membrane (not shown) is disposed between the sound hole 266 and the diaphragm 267, and the sound pressure after passage through the sound hole 266 is reduced in passing through this air-permeable membrane. Also, the diaphragm 263 and the diaphragm 267 are separated from each other (in the Z direction) by approximately 7 mm. Consequently, there is a difference between the sound pressure (electrical signal) exerted on the diaphragm 263 and the sound pressure (electrical signal) exerted on the diaphragm 267 between the non-directional microphone 261 and the non-directional microphone 265, and acoustic waves are detected based on the resulting sound pressure (electrical signals). Specifically, the non-directional microphone 261 and the non-directional microphone 265 form the unidirectional microphone 270. The unidirectional microphone 270 is an example of the “directional microphone” of the present invention.

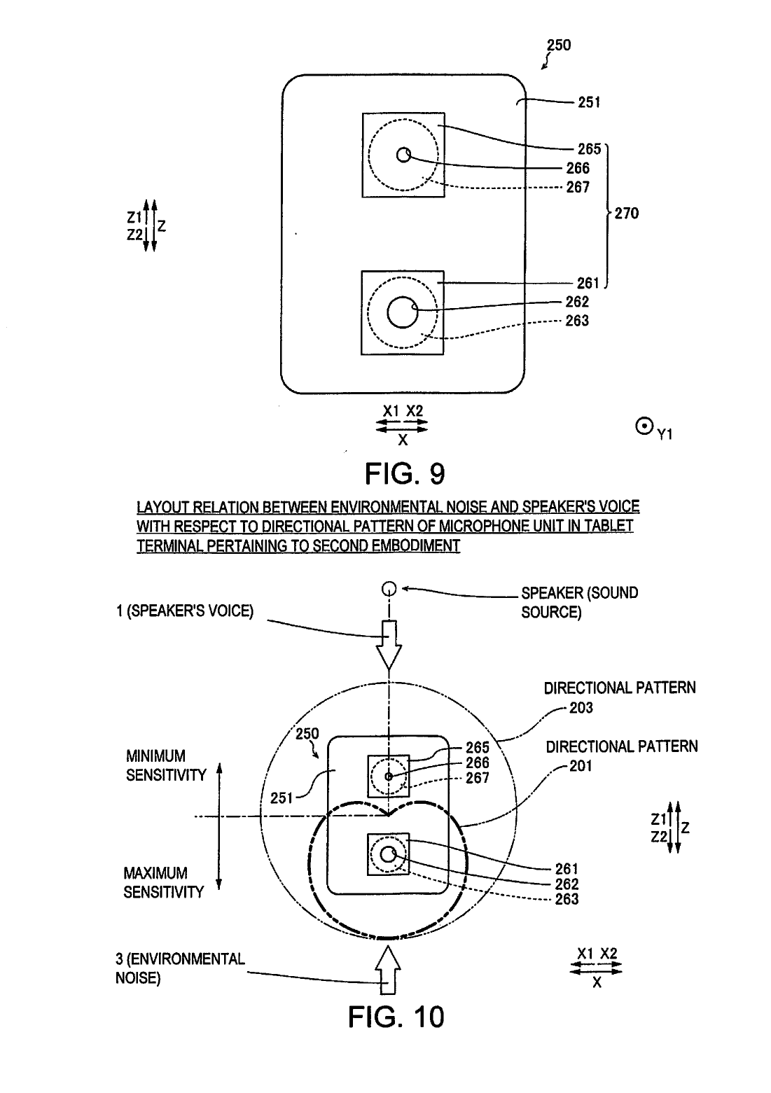

As shown in FIGS. 8 and 10, the unidirectional microphone 270 has a cardioid directional pattern (the range of directionality is indicated by the two-dot chain line 201). In this case, of the direction (Z direction) linking the centers of the sound hole 262 and the sound hole 266, the sensitivity is highest with respect to the Z2 direction, and the sensitivity is lowest (there is no sensitivity) in the opposite Z1 direction. In FIG. 10, the angle range of deviation from the cardioid directional pattern (in the drawing, the region having an angle α2 to the left and right and flanked by the two mutually intersecting broken lines 202) is the null region, in which there is no sensitivity of acoustic waves (audio) whatsoever. The paired non-directional microphone 261 and non-directional microphone 265 forming the unidirectional microphone 270 are disposed so as to be aligned in the Z direction facing the speaker's voice 1. A hole 223a is formed in the upper end face 223 of the housing 220. The hole 223a opens to the outside at an intermediate position (Z direction) between the sound hole 262 and the sound hole 266. The microphone unit 250 is disposed on the rear side of the upper end face 223 so that the sound hole 262 and the sound hole 266 will not overlap the hole 223a (cannot be seen from the hole 223a).

In the second embodiment, the diaphragm 263 on one side of the unidirectional microphone 270 also serves as the diaphragm of the non-directional microphone 261. That is, the non-directional microphone 261 has a 360-degree directional pattern (the directionality indicated by the two-dot chain line 203 in FIG. 10), and the diaphragm 263 has the function of detecting acoustic waves (audio) at the same sensitivity from all directions, and outputting electrical signals.

Consequently, in the second embodiment, as shown in FIGS. 7 and 8, the microphone unit 250 is installed in the housing 220 so that the null region in which directional sensitivity is relatively low (the arrow Z1 direction in which the display component 210 side faces) is faced toward the speaker's voice 1 emitted by the speaker (sound source), making it possible for the unidirectional microphone 270 to acquire the environmental noise 3 from the direction in which directional sensitivity is relatively high (the direction in which the rear face side of the tablet terminal 200 faces, mainly along the Z2 direction, the opposite of the Z1 direction). As shown in FIG. 5, in a state in which the microphone unit 250 has been installed in the above-mentioned direction, the audio signal processor 70 (the first audio signal processor 70a) performs subtraction processing (audio signal processing to subtract the environmental noise 3 from the speaker's voice 1 including the environmental noise 3 (noise reduction processing)) on both the speaker's voice 1 including the environmental noise 3 acquired by the non-directional microphone 261, and the environmental noise 3 acquired by the unidirectional microphone 270 when both of these two sets of data are present. Here, a situation in which the data sets acquired by the non-directional microphone 261 and the unidirectional microphone 270 are both present encompasses a situation in which the environmental noise 3 is acquired by the unidirectional microphone 270 at the same timing as the non-directional microphone 261. The speaker's voice 1 including the environmental noise 3 acquired by the non-directional microphone 261 is an example of the “data outputted by the omnidirectional microphone” in the present invention. The environmental noise 3 acquired by the unidirectional microphone 270 is an example of the “data outputted by the directional microphone” in the present invention. Thus, in the illustrated embodiment, the first audio signal processor 70a performs the subtraction processing in which the data outputted by the unidirectional microphone 270 is subtracted from the data outputted by the non-directional microphone 261. Also, in the illustrated embodiment, the first audio signal processor 70a performs the subtraction processing in which the data outputted by the unidirectional microphone 270 is subtracted from the data outputted by the non-directional microphone 261 after the second audio signal processor 70b performing the data processing of the data inputted from the unidirectional microphone 270. Also, as illustrated in FIG. 5, the second audio signal processor 70b is electrically disposed between the unidirectional microphone 270 and the first audio signal processor 70a. Also, in the illustrated embodiment, as shown in FIGS. 7 and 8, the unidirectional microphone 270 is arranged inside the housing 220 such that a direction in which the unidirectional microphone 270 has the lowest directional sensitivity is parallel to the arrow Z1 direction from the unidirectional microphone 270 toward the display component 210. Furthermore, as shown in FIGS. 7 and 8, the unidirectional microphone 270 is arranged inside the housing 220 such that the direction in which the unidirectional microphone 270 has the lowest directional sensitivity is parallel to a normal direction (e.g., the arrow Z1 direction) of the upper face 222 of the tablet terminal 200.

Again in this case, the non-directional microphone 261 picks up the speaker's voice 1 including the environmental noise 3 that varies from one moment to the next. The unidirectional microphone 270 also picks up the environmental noise 3, which varies from one moment to the next. With the first audio signal processor 70a, continuous spectrum subtraction processing is performed by independently and simultaneously subjecting the electrical signals (audio signals) based on the speaker's voice 1 including the environmental noise 3 that is picked up by the non-directional microphone 261 and that varies from moment to moment, and the electrical signals (audio signals) based on the environmental noise 3 that is picked up by the unidirectional microphone 270 and that varies from moment to moment, to fast Fourier transformation. The electrical signals (audio signals) that have undergone continuous spectrum subtraction processing are then subjected to inverse fast Fourier transformation to extract the speaker's voice 1.

At the microphone unit 250, the arrival direction of the speaker's voice 1 and the arrival direction of the environmental noise 3 are mutually opposite directions (inverted by 180 degrees). Accordingly, wraparound of the speaker's voice 1 will not affect the environmental noise 3. In actual practice, in a situation in which the tablet terminal 200 is operated while the user looks at a television set or the like (not shown), the layout relation between the environmental noise 3 and the speaker's voice 1 corresponds to the above relation.

Consequently, with the tablet terminal 200, even when the speaker's voice 1 is emitted from a position where the speaker (user) is a distance of distinct vision away (about 250 mm), because the audio signal processor 70 is provided, which performs independent audio signal processing (processing to remove background noise signals) so that the orientation is properly set to take into account the directional characteristics of the unidirectional microphone 270 built into the microphone unit 250, and is matched to the orientation that takes into account the directional characteristics of the unidirectional microphone 270, the environmental noise 3 can be minimized along with clearly distinguishing (determining) the environmental noise 3 from the voice emitted by the speaker (the speaker's voice 1 originally included in the environmental noise 3), and the original speaker's voice 1 can be extracted in a state that is close to how it was at the outset. The rest of the configuration of the tablet terminal 200 of the second embodiment are the same as in the first embodiment above.

The following effects can be obtained with the second embodiment.

As discussed above, in the second embodiment, the microphone unit 250 is configured using the unidirectional microphone 270. Consequently, the directionality (unidirectionality) of the unidirectional microphone 270 can be effectively utilized to acquire the environmental noise 3 at good sensitivity. Also, background noise signals can be removed based on simultaneous and continuous audio signal processing of the speaker's voice 1 including the environmental noise 3 acquired independently by the non-directional microphone 261, and the environmental noise 3 acquired independently by the unidirectional microphone 270. Specifically, since the speaker's voice 1 can be extracted by subtracting the environmental noise 3 present at the same clock time from the speaker's voice 1 that includes the environmental noise 3, main audio that is that much closer to the original (a speaker's voice 1 that is more natural) can be obtained. Therefore, again with the compact microphone unit 250, there will be less of a decrease in the quality of the speaker's voice 1 after audio signal processing. Also, the existing unidirectional microphone 270 can be used to easily obtain a tablet terminal 200 in which the decrease in the quality of the speaker's voice 1 after audio signal processing can be suppressed.

Also, in the second embodiment, the unidirectional microphone 270 is configured to have the pair of diaphragms 263 and 267, and to detect acoustic waves based on the difference in sound pressure exerted on these diaphragms 263 and 267. The diaphragm 263 on one side of the unidirectional microphone 270 also serves as the diaphragm 263 of the non-directional microphone 261. Consequently, the unidirectional microphone 270 structured to detect acoustic waves based on the difference in sound pressure exerted on the pair of diaphragms 263 and 267 can be effectively utilized, and the diaphragm 263 on one side can be used as the output of the non-directional microphone 261, so the tablet terminal 200 will have fewer parts than when the unidirectional microphone 270 and the non-directional microphone 261 that does not form this unidirectional microphone 270 are provided separately.

Also, in the second embodiment, the configuration is such that the paired non-directional microphones 261 and 265 are disposed in the unidirectional microphone 270 so as to be aligned in the Z direction facing the direction in which the speaker's voice 1 arrives. Consequently, the unidirectional microphone 270 can be easily disposed in the interior of the housing 220 so that the direction in which directional sensitivity is relatively low (null region: within an angular range in which no sensitivity is obtained with directionality) is facing in the direction from which the speaker's voice 1 arrives (the arrow Z1 direction), and the environmental noise 3 is acquired from the direction in which directional sensitivity is relatively high (Z2 side). The rest of the effects of the second embodiment are the same as in the first embodiment above.

### Third Embodiment

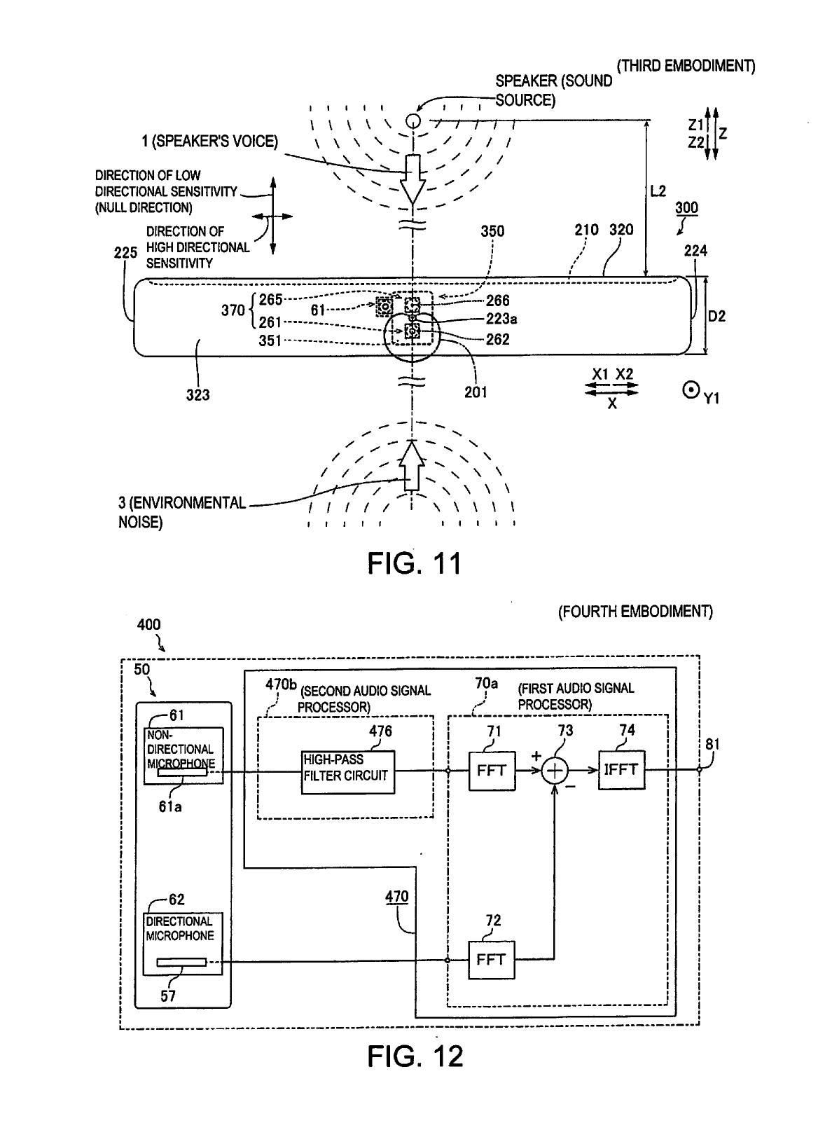

Referring now to FIGS. 5 and 11, a tablet terminal 300 in accordance with a third embodiment will now be explained. In view of the similarity between the first to third embodiments, the parts of the third embodiment that are identical to the parts of the first or second embodiment will be given the same reference numerals as the parts of the first or second embodiment. Moreover, the descriptions of the parts of the third embodiment that are identical to the parts of the first or second embodiment may be omitted for the sake of brevity. With the tablet terminal 300 in the third embodiment, unlike in the first embodiment above, a microphone unit 350 is configured using a single non-directional microphone 61 (omnidirectional microphone), apart from a unidirectional microphone 370 consisting of the non-directional microphone 261 (omnidirectional microphone) and the non-directional microphone 265 (omnidirectional microphone). Also, in the drawings, those components that are the same as in the second embodiment will be numbered the same as in the second embodiment. The tablet terminal 300 is an example of the “microphone device” of the present invention.

As shown in FIG. 11, the tablet terminal 300 includes a compact microphone unit 350 on the inside of an upper end face 323 of a housing 320. The microphone unit 350 has a unidirectional microphone 370 and one non-directional microphone 61. The non-directional microphone 61 is disposed to the side (the arrow X2 direction side) on the substrate 351 apart from the unidirectional microphone 370.

Consequently, in the third embodiment, the microphone unit 350 is installed in the housing 320 so that the unidirectional microphone 370 can acquire the environmental noise 3 from the direction in which directional sensitivity is relatively high (mainly along the Z2 direction, the opposite of the Z1 direction) by having the direction in which directional sensitivity is relatively low (the arrow Z1 direction) face toward the speaker's voice 1 emitted from the speaker (sound source). Also, in a state in which the microphone unit 350 is installed in the above-mentioned direction, the audio signal processor 70 (see FIG. 5) is configured to perform subtraction processing (audio signal processing (noise reduction processing) to subtract the environmental noise 3 from the speaker's voice 1 including the environmental noise 3) on both the speaker's voice 1 including the environmental noise 3 acquired by the non-directional microphone 61, and the environmental noise 3 acquired by the unidirectional microphone 370 (the environmental noise 3 acquired by the unidirectional microphone 370 at the same timing as the non-directional microphone 61) when both of these are present. Here, a situation in which the data sets acquired by the non-directional microphone 61 and the unidirectional microphone 370 are both present encompasses a situation in which the environmental noise 3 is acquired by the unidirectional microphone 370 at the same timing as the non-directional microphone 61. The environmental noise 3 acquired by the unidirectional microphone 370 is an example of the “data outputted by the directional microphone” in the present invention. Thus, in the illustrated embodiment, the first audio signal processor 70a performs the subtraction processing in which the data outputted by the unidirectional microphone 370 is subtracted from the data outputted by the non-directional microphone 61. Also, in the illustrated embodiment, the first audio signal processor 70a performs the subtraction processing in which the data outputted by the unidirectional microphone 370 is subtracted from the data outputted by the non-directional microphone 61 after the second audio signal processor 70b performing the data processing of the data inputted from the unidirectional microphone 370. Also, as illustrated in FIG. 5, the second audio signal processor 70b is electrically disposed between the unidirectional microphone 370 and the first audio signal processor 70a. Also, in the illustrated embodiment, as shown in FIGS. 7 and 11, the unidirectional microphone 370 is arranged inside the housing 320 such that a direction in which the unidirectional microphone 370 has a lowest directional sensitivity is parallel to the arrow Z1 direction from the unidirectional microphone 370 toward the display component 210. Furthermore, as shown in FIGS. 7 and 11, the unidirectional microphone 370 is arranged inside the housing 320 such that the direction in which the unidirectional microphone 370 has the lowest directional sensitivity is parallel to a normal direction (e.g., the arrow Z1 direction) of the upper face 222 of the tablet terminal 300.

Here again, the non-directional microphone 61 picks up the speaker's voice 1 including the environmental noise 3 that varies from one moment to the next. The unidirectional microphone 370 picks up the environmental noise 3 that varies from one moment to the next. The first audio signal processor 70a (see FIG. 5) then performs continuous spectrum subtraction processing by independently and simultaneously subjecting the electrical signals (audio signals) based on the speaker's voice 1 including the environmental noise 3 that is picked up by the non-directional microphone 61 and that varies from moment to moment, and the electrical signals (audio signals) based on the environmental noise 3 that is picked up by the unidirectional microphone 370 and that varies from moment to moment, to fast Fourier transformation. The electrical signals (audio signals) that have undergone continuous spectrum subtraction processing are then subjected to inverse fast Fourier transformation to extract the speaker's voice 1.

Consequently, with the tablet terminal 300, even when the speaker's voice 1 is emitted from a position where the speaker (user) is a distance of distinct vision away (about 250 mm), because the audio signal processor 70 is provided, which performs independent audio signal processing (processing to remove background noise signals) so that the orientation of the unidirectional microphone 370 built into the microphone unit 350 is properly set, and is matched to the orientation of the unidirectional microphone 370, the environmental noise 3 can be minimized along with clearly distinguishing (determining) the environmental noise 3 from the voice emitted by the speaker (the speaker's voice 1 originally included in the environmental noise 3), and the original speaker's voice 1 can be extracted in a state that is close to how it was at the outset. The rest of the configuration of the tablet terminal 300 in the third embodiment is the same as in the first embodiment above.

The following effects can be obtained with the third embodiment.

As discussed above, in the third embodiment, the microphone unit 250 is configured by separately providing the non-directional microphone 61 and the unidirectional microphone 370. Here again, background noise signals can be removed based on simultaneous and continuous audio signal processing of the speaker's voice 1 including the environmental noise 3 independently acquired by the non-directional microphone 61, and the environmental noise 3 independently acquired by the unidirectional microphone 370. Specifically, since the speaker's voice 1 can be extracted by subtracting the environmental noise 3 present at the same clock time from the speaker's voice 1 that includes the environmental noise 3, main audio that is that much closer to the original (a speaker's voice 1 that is more natural) can be obtained. Therefore, again with the compact microphone unit 350, there will be less of a decrease in the quality of the speaker's voice 1 after audio signal processing. The rest of the effects of the third embodiment are the same as in the second embodiment above.

### Fourth Embodiment

Referring now to FIG. 12, a portable information terminal 400 in accordance with a fourth embodiment will now be explained. In view of the similarity between the first to fourth embodiments, the parts of the fourth embodiment that are identical to the parts of the first, second or third embodiment will be given the same reference numerals as the parts of the first, second or third embodiment. Moreover, the descriptions of the parts of the fourth embodiment that are identical to the parts of the first, second or third embodiment may be omitted for the sake of brevity. With the portable information terminal 400 in this fourth embodiment, an audio signal processor 470 (signal processor) is formed by disposing a second audio signal processor 470b (second signal processor) between the non-directional microphone 61 and the first audio signal processor 70a. In the drawing, those components that are the same as in the first embodiment above are numbered the same as in the first embodiment. The portable information terminal 400 is an example of the “microphone device” in the present invention.

Specifically, as shown in FIG. 12, the second audio signal processor 470b is configured to include a high-pass filter circuit 476 for adjusting the sensitivity level of an electrical signal (audio signal) outputted from the non-directional microphone 61.

In this case, the sensitivity of the non-directional microphone 61 in the low-frequency band is decreased when the electrical signal (audio signal) passes through the high-pass filter circuit 476. Therefore, the sensitivity characteristics (frequency characteristics) of the non-directional microphone 61 are configured to match (approximate) the sensitivity characteristics (frequency characteristics) of the bidirectional microphone 62. The high-pass filter circuit 476 can be put to good use in matching up the sensitivity characteristics when the main portion of an audio signal is in the high-frequency band of an electrical signal outputted from the non-directional microphone 61, or when noise is extremely loud in the low-frequency band. The rest of the configuration of the portable information terminal 400 in the fourth embodiment is the same as in the first embodiment above.

The fourth embodiment has the following effects.

As discussed above, with the fourth embodiment, the second audio signal processor 470b is formed by the high-pass filter circuit 476, which is disposed between the non-directional microphone 61 and the first audio signal processor 70a. Specifically, the second audio signal processor 470b is electrically disposed between the non-directional microphone 61 and the first audio signal processor 70a. Consequently, the second audio signal processor 470b can easily match the sensitivity characteristics (frequency characteristics) had by the bidirectional microphone 62 to the sensitivity characteristics (frequency characteristics) had by the non-directional microphone 61. Specifically, the second audio signal processor 470b including the high-pass filter circuit 476 can easily obtain the electrical conditions necessary to remove the environmental noise 3 acquired by the bidirectional microphone 62 from the speaker's voice 1 including the environmental noise 3 acquired by the non-directional microphone 61. The rest of the effects in the fourth embodiment are the same as in the first embodiment above. As shown in FIG. 12, in the illustrated embodiment, the first audio signal processor 70a performs the subtraction processing in which the data outputted by the bidirectional microphone 62 is subtracted from the data outputted by the non-directional microphone 61. Also, in the illustrated embodiment, the first audio signal processor 70a performs the subtraction processing in which the data outputted by the bidirectional microphone 62 is subtracted from the data outputted by the non-directional microphone 61 after the second audio signal processor 470b performing the data processing of the data inputted from the non-directional microphone 61.

### Fifth Embodiment

Referring now to FIGS. 1, 2, 5 and 13, a portable information terminal 500 in accordance with a fifth embodiment will now be explained. In view of the similarity between the first to fifth embodiments, the parts of the fifth embodiment that are identical to the parts of the first, second, third or fourth embodiment will be given the same reference numerals as the parts of the first, second, third or fourth embodiment. Moreover, the descriptions of the parts of the fifth embodiment that are identical to the parts of the first, second, third or fourth embodiment may be omitted for the sake of brevity. With the portable information terminal 500 in this fifth embodiment, the sensitivity level of the bidirectional microphone 62 is offset, and processing computation that is different from that of the portable information terminal 100 (first embodiment), in which the angle dependence of the sensitivity of the environmental noise 3 is reduced, is used to reduce the angle dependence of the sensitivity of the directional microphone. In the drawings, those components that are the same as in the first embodiment are numbered the same as in the first embodiment. The portable information terminal 500 is an example of the “microphone device” of the present invention.

As shown in FIGS. 1 and 5, the portable information terminal 500 has the same hard configuration as the portable information terminal 100. In the fifth embodiment, however, the audio signal processing to make the frequency characteristics had by the bidirectional microphone 62 approximate the frequency characteristics had by the non-directional microphone 61 is performed by a different method from that with the portable information terminal 100.

More specifically, with the method employed here, in obtaining a specific or higher output (audio including noise) from the bidirectional microphone 62 at a certain time interval, the amplification ratio of the amplifier 75 (see FIG. 5) is gradually changed, and the amplifier 75 is adjusted to the amplification ratio at the point when a frequency is generated at which the signal value after spectrum subtraction processing at the first audio signal processor 70a becomes negative. This makes use of the point at which the signal value after spectrum subtraction processing becomes substantially zero when the sensitivity level of the bidirectional microphone 62 is properly adjusted, for sound having a frequency generated from only the direction in which directional sensitivity of the bidirectional microphone 62 is high (the X direction in FIG. 2).

Specifically, this is because even when the sensitivity level for the bidirectional microphone 62 has been properly adjusted for the speaker's voice 1 (frequency) generated from the direction in which the speaker is located (the Z direction in FIG. 2), the signal value after subtraction processing by the subtractor 73 (see FIG. 5) will be a positive value, but even when the sensitivity level for the bidirectional microphone 62 has been properly adjusted for the environmental noise 3 generated only from the X direction in FIG. 2, the signal value after subtraction processing by the subtractor 73 will be substantially zero. The portable information terminal 500 has a mode for adjusting the sensitivity of the bidirectional microphone 62 as above. The control processing flow in this adjustment mode will now be described.

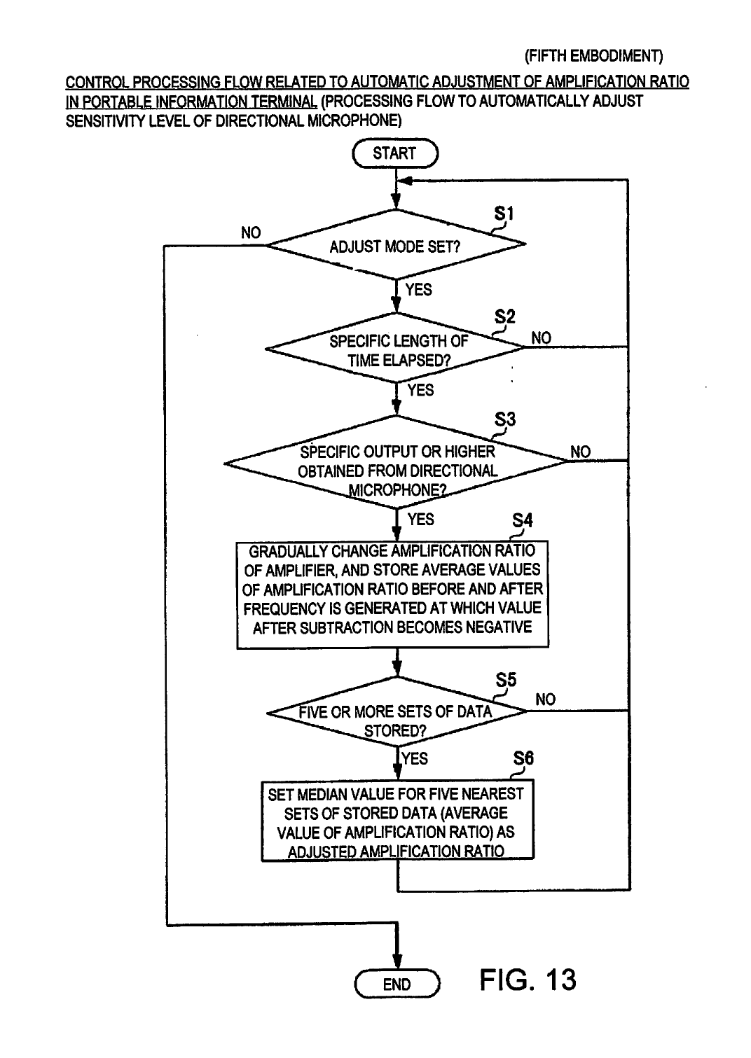

As shown in FIG. 13, first, in step S1, the controller (not shown) on the device main body side of the portable information terminal 500 determines whether or not the user has set the portable information terminal 500 to “adjust mode.” Setting to adjust mode is performed by the user through the display component 10 (see FIG. 1), which is in the form of a touch panel.

If in step S1 it is determined that the portable information terminal 500 has been set to adjust mode (Yes in step S1), then in step S2 it is determined whether or not a specific length of time (such as two seconds) has elapsed. If in step S2 it is determined that a specific length of time has elapsed (Yes in step S2), then in step S3 it is determined whether or not there is a frequency (spectrum) having at least a specific output (audio) from the bidirectional microphone 62. On the other hand, if it is determined that the specific length of time has not elapsed (No in step S2), then the process goes back to step S1.

If in step S3 it is determined that there is a frequency having at least a specific output (audio) from the bidirectional microphone 62 (Yes in step S3), then in step S4 the amplification ratio of the amplifier 75 (see FIG. 5) is gradually varied in specific width increments, while storing the average value for the amplification ratio before and after the point when a frequency (spectrum) is obtained at which the signal value produced by the subtractor 73 (see FIG. 5) (the signal value obtained by subtracting the spectrum for the bidirectional microphone 62 obtained by the FFT component 72 from the spectrum for the non-directional microphone 61 obtained by the FFT component 71) becomes negative. On the other hand, if it is determined that there is no frequency having at least a specific output (audio) from the bidirectional microphone 62 (No in step S3), then the process goes back to step S1.

After this, in step S5, it is determined whether or not five or more sets of the data stored in step S4 (the average value of the amplification ratio) have accumulated, and if there are five or more sets of stored data in step S4 (Yes in step S5), then in step S6 the median value for the five closest sets of stored data (the average value of the amplification ratio) are set as the adjusted amplification ratio in the amplifier 75. After this, the processing flow returns to step S1. On the other hand, if it is determined that there are not five or more sets of stored data in step S4 (No in step S5), then the process goes back to step S1.

This processing flow is ended when the setting of the “adjust mode” is released (switched off) via the display component 10 at the point when the user determines that the sensitivity level of the bidirectional microphone 62 is suitably adjusted (or that the environmental noise 3 has been suppressed and clear sound has been obtained) while the user listening to audio emitted from the speaker 11 (see FIG. 1) or the like. If the user has not switched on the “adjust mode” for the portable information terminal 500 in step S1 (No in step S1), then this processing flow is not performed, and the flow is ended. Also, if the user listens to the audio from the speaker 11 and feels that the output from the microphone unit 50 includes a lot of environmental noise 3, the “adjust mode” is switched back on. This causes the above processing flow to be executed again, and the amplification ratio of the amplifier 75 is automatically adjusted. The rest of the configuration of the portable information terminal 500 in the fifth embodiment is the same as in the first embodiment above.

The fifth embodiment has the following effects.

As discussed above, with the fifth embodiment, a method is employed in which the amplification ratio of the amplifier 75 is gradually changed to adjust the amplifier 75 to the amplification ratio at the point when a frequency is generated at which the signal value after spectrum subtraction processing at the first audio signal processor 70a becomes negative. Consequently, the amplification ratio of the amplifier 75 can be precisely adjusted to suit the environment in which the microphone unit 50 acquires audio. Therefore, a high-quality speaker's voice 1 having good clarity can always be provided.

Also, the fifth embodiment is configured so that whether or not to execute the adjust mode on the amplification ratio of the amplifier 75 as discussed above is determined based on a user operation. Therefore, there is no need to perform computation processing related to the adjust mode when the amplification ratio does not need to be adjusted, so the processing burden on the controller is reduced, and a clear speaker's voice 1 can be provided without any delay.

The embodiments disclosed herein are just examples in every respect, and should not be interpreted as being limiting in nature. The scope of the invention being indicated by the appended claims rather than by the above description of the embodiments, all modifications within the meaning and range of equivalency of the claims are included.

For example, in the first and fifth embodiments above, an example is given of using the bidirectional microphone 62 as a directional microphone, and in the second embodiment above, of using the unidirectional microphone 270 as a directional microphone, but the present invention is not limited to this. With the present invention, besides a bidirectional or unidirectional microphone, a directional microphone having a super-cardioid or hyper-cardioid type of directional pattern can be used, for example. If the direction in which directional sensitivity is relatively low in these directional microphones is disposed so as to face toward the speaker's voice 1, then the interior of the microphone device (microphone unit) can be configured so that the environmental noise 3 is acquired from the direction in which directional sensitivity is relatively high.

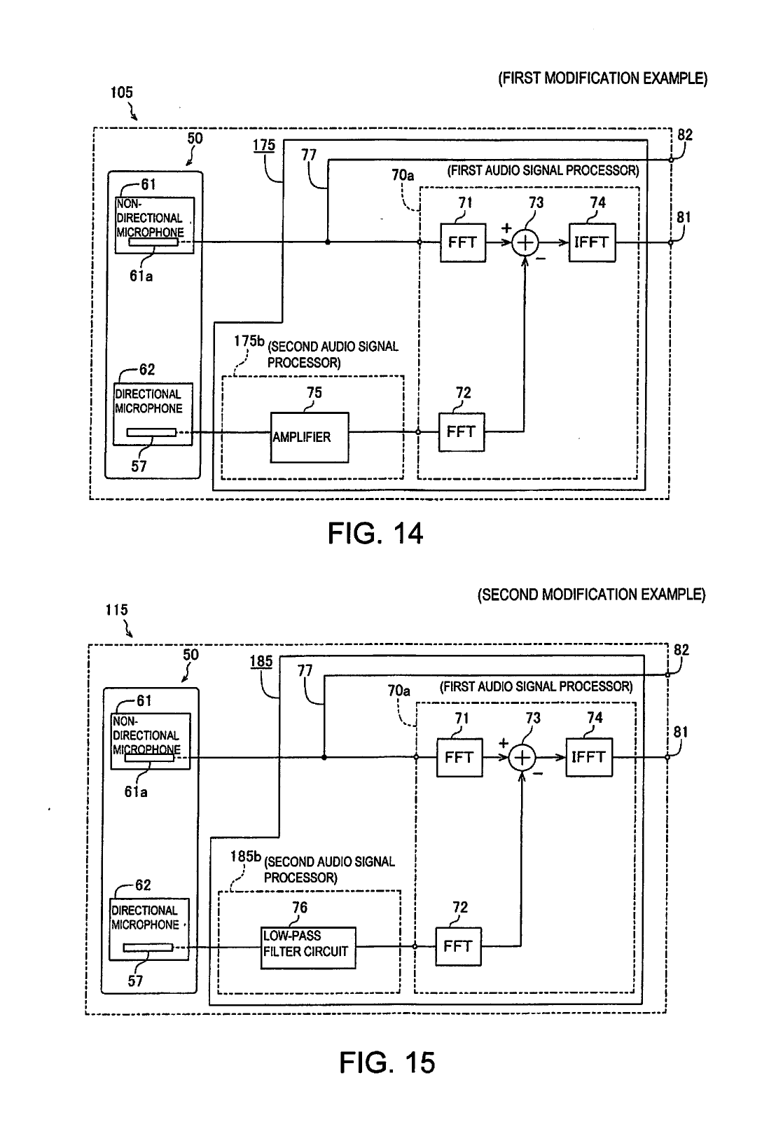

Also, in the first to third and the fifth embodiments above, an example is given in which the second audio signal processor 70b is formed by the amplifier 75 and the low-pass filter circuit 76, but the present invention is not limited to this. Specifically, the important thing is that the sensitivity characteristics (frequency characteristics) of the directional microphone should match the sensitivity characteristics (frequency characteristics) of the non-directional microphone, so the amplifier 75 and the low-pass filter circuit 76 need not be provided. Alternatively, as in the first modification example shown in FIG. 14, an audio signal processor 175 (signal processor) of a portable information terminal 105 can be formed by a second audio signal processor 175b (second signal processor) equipped with only the amplifier 75, to match the sensitivity characteristics (frequency characteristics) of the directional microphone 62 being used. As illustrated in FIG. 14, the second audio signal processor 175b is electrically disposed between the bidirectional microphone 62 and the first audio signal processor 70a. Also, as in the second modification example shown in FIG. 15, an audio signal processor 185 (signal processor) of a portable information terminal 115 can be formed by a second audio signal processor 185b (second signal processor) equipped with only the low-pass filter circuit 76. As illustrated in FIG. 15, the second audio signal processor 185b is electrically disposed between the bidirectional microphone 62 and the first audio signal processor 70a. As shown in FIGS. 14 and 15, in the illustrated embodiment, the first audio signal processor 70a performs the subtraction processing in which the data outputted by the bidirectional microphone 62 is subtracted from the data outputted by the non-directional microphone 61. Also, in the illustrated embodiment, the first audio signal processor 70a performs the subtraction processing in which the data outputted by the bidirectional microphone 62 is subtracted from the data outputted by the non-directional microphone 61 after the second audio signal processor 175b (185b) performing the data processing of the data inputted from the bidirectional microphone 62.

Also, in the first, fourth and fifth embodiments above, the present invention is applied to the portable information terminal 100 (400, 500), such as a smart phone, and in the second and third embodiments above, the present invention is applied to the tablet terminal 200 (300), but the present invention is not limited to this. The present invention can also be applied to a headset (acoustic device) having a microphone unit, to a portable game device, to a notebook computer, to a remote control device equipped with an audio input function for operating electronic devices, to a wireless communications device (such as a transceiver or other wireless device), or the like.

Also, in the first to fifth embodiments above, the signal output of the non-directional microphone 61 (261) is inputted directly to the FFT component 71, and the signal output of the bidirectional microphone 62 (the unidirectional microphones 270 and 370) is inputted directly to the FFT component 72 via the second audio signal processor 70b, but the present invention is not limited to this. For example, an audio signal processor can be further provided to allow the phase of the signal output of the non-directional microphone 61 (261) and the phase of the signal output of the bidirectional microphone 62 (the unidirectional microphones 270 and 370) to be corrected, and the signal outputs to be inputted to the FFT component 71 and the FFT component 72 in this state.

Also, in the first, fourth and fifth embodiments, an example is given in which the microphone unit 50 is provided at a location that is shifted by approximately 20 mm to one side (the X2 side) from the center position in the X direction of the lower end face 24 in the portable information terminal 100 (400, 500), but the present invention is not limited to this. Specifically, as long as the null direction of the bidirectional microphone 62 is included in an angle range of ±30 degrees with respect to the speaker's voice 1 at the distance of distinct vision (distance L1=approximately 250 mm), the position of the microphone unit 50 within the lower end face 24 can be something other than approximately 20 mm. For example, if the microphone unit 50 is incorporated into the lower end face 224 (length: approximately 210 mm) of the tablet terminal 200 in the second embodiment above, then the microphone unit 50 can be shifted by about 100 mm to one side (the X2 side) from the center position in the X direction of the lower end face 224.

Also, in the second and third embodiments above, an example is given in which the microphone unit 250 (350) is housed inside the housing 220 (320) in a state in which the center position in the X direction is aligned with the center position of the upper end face 223 (323) of the tablet terminal 200 (300), but the present invention is not limited to this. Specifically, the microphone unit 250 (350) can be disposed at a position that is shifted to one side (the other side) from the center position of the upper end face 223 (323) of the tablet terminal 200 (300) so that the unidirectional microphone 270 (370) is facing toward the speaker's voice 1 within the null region (within a range of an angle α2 (see FIG. 10)) on one side (the X1 side) or the other side (the X2 side).

Also, in the fifth embodiment above, an example is given of employing a method in which the amplification ratio of the amplifier 75 is automatically adjusted for the portable information terminal 500 including the bidirectional microphone 62, but the present invention is not limited to this. Specifically, a method can be employed in which the amplification ratio of the amplifier 75 is automatically adjusted for the tablet terminal 200 (300) including the unidirectional microphone 270 (370).

The microphone device in accordance with a first aspect of the present invention comprises an omnidirectional microphone, a directional microphone, and a first signal processor configured to perform subtraction processing between data outputted by the directional microphone and data outputted by the omnidirectional microphone.

The microphone device in accordance with this first aspect of the present invention, as mentioned above, comprises an omnidirectional microphone, a directional microphone, and a first signal processor that performs subtraction processing between two sets of data when data outputted by the directional microphone and data outputted by the omnidirectional microphone are both present, and therefore background noise signals can be removed based on the “subtraction processing” of the present invention, which is continuous and proceeds simultaneously for data (a speaker's voice that includes environmental noise) acquired independently by the omnidirectional microphone, and data (environmental noise) acquired independently and in real time by the directional microphone. Specifically, unlike when a conventional spectrum subtraction method is used to subtract an estimated value (average value) for data (environmental noise) acquired during a soundless period in which a speaker's voice is halted (a blank period with no main audio), from data (a speaker's voice that includes environmental noise) acquired in real time, the speaker's voice is extracted by subtracting environmental noise present at the same clock time from a speaker's voice that includes environmental noise, which allows main audio that is that much closer to the original (a speaker's voice that is more natural) to be obtained. Because there are provided a omnidirectional microphone and a directional microphone, there is no need to increase the sensitivity of the directional microphone that acquires environmental noise more than necessary, so the microphone unit that forms a microphone device can be made more compact. Consequently, a decrease in the quality of a speaker's voice after audio signal processing can be suppressed even in a microphone unit that has been made more compact.

With the microphone device in accordance with the first aspect, the first signal processor performs subtraction processing between two sets of data when data outputted by the directional microphone and data outputted by the omnidirectional microphone are both present, and therefore the “subtraction processing” in the present invention can also suitably correspond to removing spontaneous non-stationary noise, to the extent that a speaker's voice can be extracted by capturing, simultaneously and in parallel, data (a speaker's voice that includes environmental noise) that varies from one moment to the next, with an omnidirectional microphone and a directional microphone, and subtracting. Specifically, since noise elimination processing can be reliably performed with respect to transient fluctuations in environmental noise, a speaker's voice can be obtained in a state in which so-called musical noise (tonal noise produced as a side effect of noise suppression) is almost completely excluded. This allows a speaker's voice to be obtained with good clarity (a speaker's voice from which musical noise has been excluded). Also, since a speaker's voice with good clarity can be provided, a sound source (speaker's voice) for high voice recognition performance can be provided.

With the microphone device in accordance with the first aspect, it is preferable if there is further provided a second signal processor configured to perform data processing of data inputted from the directional microphone or the omnidirectional microphone, an output from the second signal processor being inputted to the first signal processor. With this configuration, the audio signal processing of the first signal processor (subtraction processing between two sets of data when data outputted by the omnidirectional microphone and data outputted by the directional microphone are both present (for example, processing to extract a speaker's voice by subtracting environmental noise acquired at the same timing from a speaker's voice)) can be performed in a state in which the frequency characteristics of the omnidirectional microphone and the frequency characteristics of the directional microphone are matched to substantially the same electrical characteristics.

In the above configuration further comprising a second signal processor, it is preferable if the second signal processor includes at least one of an amplifier that adjusts an output level and a low-pass filter circuit. With this configuration, the second signal processor can easily match the sensitivity characteristics (frequency characteristics) of the directional microphone to the sensitivity characteristics (frequency characteristics) of the omnidirectional microphone. That is, with the second signal processor that includes an amplifier and/or a low-pass filter circuit, it is easy to obtain the electrical conditions necessary to remove environmental noise acquired by the directional microphone from a speaker's voice that includes environmental noise acquired by the omnidirectional microphone.

The configuration further comprising a second signal processor preferably includes a high-pass filter circuit into which data is inputted from the omnidirectional microphone. With this configuration, the second signal processor can easily match the sensitivity characteristics (frequency characteristics) had by the directional microphone to the sensitivity characteristics (frequency characteristics) had by the omnidirectional microphone. That is, the second signal processor including the high-pass filter circuit can easily obtain the electrical conditions necessary to remove environmental noise acquired by the directional microphone from a speaker's voice that includes environmental noise acquired by the omnidirectional microphone.

With the microphone device in accordance with the first aspect, it is preferable if the first signal processor is configured to perform signal processing in which a spectrum obtained by Fourier transformation of audio acquired by the directional microphone is subtracted from a spectrum obtained by Fourier transformation of audio acquired by the omnidirectional microphone. With this configuration, the speaker's voice can be easily extracted by subtracting audio (environmental noise) acquired at good sensitivity by the directional microphone from audio (speaker's voice that includes environmental noise) acquired by the omnidirectional microphone.

With the microphone device in accordance with the first aspect, it is preferable if the directional microphone includes a bidirectional microphone, and the bidirectional microphone faces toward a speaker's voice within an angular range of 30 degrees toward a direction in which the directional sensitivity is relatively high and centered on a direction in which directional sensitivity is lowest. With this configuration, even though the bidirectional microphone is disposed so that it is inclined to the speaker's voice within a non-sensitivity region (null region: within an angular range in which no sensitivity is obtained with directionality) within 30 degrees facing the direction in which directional sensitivity is relatively high and centered on the null direction, the bidirectional microphone will not pick up the speaker's voice, and environmental noise reaching the bidirectional microphone from a direction perpendicular to the speaker's voice can be acquired with good sensitivity. For practical purposes, environmental noise can be acquired with no problem if the bidirectional microphone is thus facing the speaker's voice in an angular range of within 30 degrees facing the direction in which the directional sensitivity is relatively high, and centered on the direction in which directional sensitivity is lowest (the null direction).

With the microphone device in accordance with the first aspect, it is preferable if a sensitivity level of the directional microphone is offsettable. With this configuration, even if there is a change (decrease) in the sensitivity of the directional microphone attributable to the direction in which the environmental noise reaches the directional microphone (a direction that is inclined by a specific angle from the direction in which maximum sensitivity is obtained), since the sensitivity level can be offset (increased), there will be less change (decrease) in the microphone sensitivity according to the direction in which the environmental noise arrives. That is, the angle at which environmental noise reaches the directional microphone is not greatly affected, and the environmental noise removal performance had by audio signal processing at the first signal processor (processing to extract a speaker's voice by subtracting environmental noise from the speaker's voice) can be made more uniform.

With the microphone device in accordance with the first aspect, it is preferable if the directional microphone has a pair of diaphragms and is configured so that acoustic waves are detected based on the difference in sound pressure exerted on the two diaphragms, and one of the diaphragms of the directional microphone serves as a diaphragm for the omnidirectional microphone. With this configuration, the directional microphone with a structure that detects acoustic waves based on the difference in sound pressure exerted on the two diaphragms is effectively utilized, and the diaphragm on one side can also be used as the output of the omnidirectional microphone, so the microphone device will need fewer parts than when a directional microphone and an omnidirectional microphone that does not form this directional microphone are provided separately.

In this case, it is preferable if the directional microphone includes a unidirectional microphone formed by a pair of omnidirectional microphones each having a diaphragm, and the pair of the omnidirectional microphones of the unidirectional microphone are aligned in a direction from which a speaker's voice arrives. With this configuration, the unidirectional microphone can be easily disposed so that environmental noise is acquired from the direction in which directional sensitivity is relatively high, and so that the direction in which directional sensitivity is relatively low (null region: within an angular range in which no sensitivity is obtained with directionality) is facing in the direction from which the speaker's voice arrives.

With the microphone device in accordance with the first aspect, it is preferable if sound pressure is detected based on difference in sound pressure arriving at a single diaphragm from opposite directions via a pair of sound holes in the directional microphone, and the omnidirectional microphone is disposed within a sound path that connects one of the sound holes with one side of the single diaphragm. With this configuration, since the omnidirectional microphone is disposed within a sound path (inside a cavity) that forms the directional microphone, the omnidirectional microphone can be built into the directional microphone, which keeps the portion forming the microphone in the microphone device (the microphone unit) from becoming larger, as compared to when the omnidirectional microphone is disposed on the outside of the directional microphone.

In this case, it is preferable if the directional microphone includes a bidirectional microphone, and the pair of the sound holes in the bidirectional microphone are aligned in a direction that intersects a direction from which a speaker's voice arrives. With this configuration, the bidirectional microphone can be easily disposed so that environmental noise is acquired from the direction in which directional sensitivity is relatively high (a direction that intersects the direction from which the speaker's voice arrives), and so that the direction in which directional sensitivity is relatively low (null region: within an angular range in which no sensitivity is obtained with directionality) is facing in the direction from which the speaker's voice arrives.

With the microphone device in accordance with the first aspect, it is preferable if audio acquired by the omnidirectional microphone is outputted without going through the first signal processor. Thus, even a microphone device equipped with an amplification function for outputting the audio acquired by the omnidirectional microphone (the speaker's voice including environmental noise) directly from a speaker or the like can be given the function of the audio signal processing of the present invention (processing to extract the speaker's voice by subtracting out environmental noise by performing subtraction processing between two sets of data when data outputted by the omnidirectional microphone (the speaker's voice) and data outputted by the bidirectional microphone (the speaker's voice including environmental noise) are both present). In this respect the present invention is very useful (practical).

With the microphone device in accordance with the first aspect, it is preferable if the first signal processor performs the subtraction processing in which the data outputted by the directional microphone is subtracted from the data outputted by the omnidirectional microphone.

With the microphone device in accordance with the first aspect, it is preferable if the second signal processor is electrically disposed between the directional microphone and the first signal processor.

With the microphone device in accordance with the first aspect, it is preferable if the first signal processor performs the subtraction processing in which the data outputted by the directional microphone is subtracted from the data outputted by the omnidirectional microphone after the second signal processor performing the data processing of the data inputted from the directional microphone.

With the microphone device in accordance with the first aspect, it is preferable if the second signal processor is electrically disposed between the omnidirectional microphone and the first signal processor.

With the microphone device in accordance with the first aspect, it is preferable if the first signal processor performs the subtraction processing in which the data outputted by the directional microphone is subtracted from the data outputted by the omnidirectional microphone after the second signal processor performing the data processing of the data inputted from the omnidirectional microphone.

With the microphone device in accordance with the first aspect, it is preferable if the microphone device further comprises a housing, and a display component arranged relative to the housing, the directional microphone being arranged inside the housing such that a direction in which the directional microphone has a lowest directional sensitivity is parallel to a direction from the directional microphone toward the display component.

With the microphone device in accordance with the first aspect, it is preferable if the directional microphone is arranged inside the housing such that the direction in which the directional microphone has the lowest directional sensitivity is parallel to a normal direction of an upper face of the microphone device.

The microphone unit in accordance with a second aspect of the present invention is used in a microphone device including a microphone unit that includes an omnidirectional microphone and a directional microphone, and an signal processor configured to perform subtraction processing between data outputted by the directional microphone and data outputted by the omnidirectional microphone.

As discussed above, the microphone unit in accordance with the second aspect of this invention comprises an omnidirectional microphone and a directional microphone, and is used in the microphone device comprising the signal processor configured to perform subtraction processing between two sets of data when data outputted by the directional microphone and data outputted by the omnidirectional microphone are both present. Consequently, background noise signals can be removed based on subtraction processing that is continuous and proceeds simultaneously for data (a speaker's voice that includes environmental noise) acquired independently by the omnidirectional microphone, and data (environmental noise) acquired independently and in real time by the directional microphone. Specifically, unlike when using a conventional spectrum subtraction method to subtract the estimated value (average value) for data (environmental noise) acquired during a soundless period (a blank period in which there is no main audio) in which a speaker's voice is halted, from data (a speaker's voice that includes environmental noise) acquired in real time, the speaker's voice can be extracted by subtracting environmental noise present at the same clock time from a speaker's voice that includes environmental noise, which allows main audio that is that much closer to the original (a speaker's voice that is more natural) to be obtained. Furthermore, because the microphone unit comprises the omnidirectional microphone and the directional microphone, there is no need to increase the sensitivity of the directional microphone that acquires environmental noise more than necessary, so the microphone unit that forms the microphone device can be made more compact. Consequently, a decrease in the quality of a speaker's voice after audio signal processing can be suppressed even in a microphone unit that has been made more compact.

With the microphone unit in accordance with the second aspect, the first signal processor of the microphone device performs subtraction processing between two sets of data when data outputted by the directional microphone data outputted by the omnidirectional microphone are both present, and therefore the “subtraction processing” in the present invention can also suitably correspond to removing spontaneous non-stationary noise, to the extent that a speaker's voice can be extracted by capturing, simultaneously and in parallel, data (a speaker's voice that includes environmental noise) that varies from one moment to the next, with an omnidirectional microphone and a directional microphone, and subtracting. Specifically, since noise elimination processing can be reliably performed with respect to transient fluctuations in environmental noise, a speaker's voice can be obtained in a state in which so-called musical noise (tonal noise produced as a side effect of noise suppression) is almost completely excluded. The use of this microphone unit allows a speaker's voice to be obtained with good clarity (a speaker's voice from which musical noise has been excluded).

As discussed above, the present invention provides a microphone device with which a decrease in the quality of a speaker's voice after audio signal processing can be suppressed even in a microphone unit that has been made more compact, as well as a microphone unit that is used in this microphone device.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A microphone device comprising:
an omnidirectional microphone;
a directional microphone; and
a first signal processor that performs subtraction processing between data outputted by the directional microphone and data outputted by the omnidirectional microphone.

2. The microphone device according to claim 1, further comprising
a second signal processor that performs data processing of data inputted from the directional microphone or the omnidirectional microphone,
an output from the second signal processor being inputted to the first signal processor.

3. The microphone device according to claim 2, wherein
the second signal processor includes at least one of an amplifier that adjusts an output level and a low-pass filter circuit.

4. The microphone device according to claim 2, wherein
the second signal processor includes a high-pass filter circuit into which data is inputted from the omnidirectional microphone.

5. The microphone device according to claim 1, wherein
the first signal processor performs signal processing in which a spectrum obtained by Fourier transformation of audio acquired by the directional microphone is subtracted from a spectrum obtained by Fourier transformation of audio acquired by the omnidirectional microphone.

6. The microphone device according to claim 1, wherein
the directional microphone includes a bidirectional microphone, and
the bidirectional microphone faces toward a speaker's voice within an angular range of 30 degrees toward a direction in which directional sensitivity is relatively high and centered on a direction in which directional sensitivity is lowest.

7. The microphone device according to claim 1, wherein
a sensitivity level of the directional microphone is offsettable.

8. The microphone device according to claim 1, wherein
the directional microphone has a pair of diaphragms, with acoustic waves being detected based on difference in sound pressure exerted on the diaphragms, and
one of the diaphragms of the directional microphone serves as a diaphragm for the omnidirectional microphone.

9. The microphone device according to claim 8, wherein
the directional microphone includes a unidirectional microphone with a pair of omnidirectional microphones each having a diaphragm, and
the pair of the omnidirectional microphones of the unidirectional microphone are aligned in a direction from which a speaker's voice arrives.

10. The microphone device according to claim 1, wherein
sound pressure is detected based on difference in sound pressure arriving at a single diaphragm from opposite directions via a pair of sound holes in the directional microphone, and
the omnidirectional microphone is disposed within a sound path that connects one of the sound holes with one side of the single diaphragm.

11. The microphone device according to claim 10, wherein
the directional microphone includes a bidirectional microphone, and
the pair of the sound holes in the bidirectional microphone are aligned in a direction that intersects a direction from which a speaker's voice arrives.

12. The microphone device according to claim 1, wherein
audio acquired by the omnidirectional microphone is outputted without going through the first signal processor.

13. The microphone device according to claim 1, wherein
the first signal processor performs the subtraction processing in which the data outputted by the directional microphone is subtracted from the data outputted by the omnidirectional microphone.

14. The microphone device according to claim 2, wherein
the second signal processor is electrically disposed between the directional microphone and the first signal processor.

15. The microphone device according to claim 2, wherein
the first signal processor performs the subtraction processing in which the data outputted by the directional microphone is subtracted from the data outputted by the omnidirectional microphone after the second signal processor performing the data processing of the data inputted from the directional microphone.

16. The microphone device according to claim 2, wherein
the second signal processor is electrically disposed between the omnidirectional microphone and the first signal processor.

17. The microphone device according to claim 2, wherein
the first signal processor performs the subtraction processing in which the data outputted by the directional microphone is subtracted from the data outputted by the omnidirectional microphone after the second signal processor performing the data processing of the data inputted from the omnidirectional microphone.

18. The microphone device according to claim 1, further comprising
a housing; and
a display component arranged relative to the housing,
the directional microphone being arranged inside the housing such that a direction in which the directional microphone has a lowest directional sensitivity is parallel to a direction from the directional microphone toward the display component.

19. The microphone device according to claim 18, wherein
the directional microphone is arranged inside the housing such that the direction in which the directional microphone has the lowest directional sensitivity is parallel to a normal direction of an upper face of the microphone device.

20. A microphone unit used in a microphone device including a microphone unit that includes an omnidirectional microphone and a directional microphone, and an signal processor that performs subtraction processing between data outputted by the directional microphone and data outputted by the omnidirectional microphone.
